(19) United States
(12) Patent Application Publication
(10) Pub. No.: US 2022/0164910 A1
(43) Pub. Date: May 26, 2022

(54) PRIORITIZED TRANSPORTATION REQUESTS FOR A DYNAMIC TRANSPORTATION MATCHING SYSTEM

(71) Applicant: Lyft, Inc., San Francisco, CA (US)

(72) Inventors: Janie Jia Gu, San Francisco, CA (US); Arman Jabbari, Seattle, WA (US); Krishna Kumar Selvam, San Francisco, CA (US)

(21) Appl. No.: 16/953,899

(22) Filed: Nov. 20, 2020

(51) Int. Cl. G06Q 50/30; G06Q 10/06; G06Q 30/02; G06Q 30/08; G06Q 10/02; G01C 21/34

(52) U.S. Cl. CPC G06Q 50/30; G06Q 10/06315; G06Q 30/0284; G06Q 10/06312; G06F 3/0482; G06Q 10/02; G01C 21/343; G01C 21/3453; G06Q 30/08

(57) ABSTRACT

The present disclosure relates to systems, non-transitory computer-readable media, and methods for identifying provider devices and corresponding vehicles as candidates to transport time-sensitive (or otherwise prioritized) requestors and providing prioritized transportation options as fast passes for display on such requestors' devices. To provide such a prioritized transportation option, the disclosed systems can identify provider devices either matched or unmatched with requestors as candidates for prioritized transport based on estimated times of arrivals (ETAs) of vehicles for the candidate provider devices at the requestor's pickup location. Based on the ETAs at the pickup location, the disclosed systems can select a closest provider device from among the candidate provider devices to transport a prioritized requestor. After matching the prioritized requestor to the closest provider device, the disclosed systems can further search for providers with sooner ETAs.

### BACKGROUND

Ride-sharing systems commonly use web and mobile applications to manage on-demand requests for transportation from providers. By using such web and mobile applications, on-demand transportation matching systems pair providers with requestors to transport such requestors from a pickup location to a drop-off location. In recent years, ride-sharing systems have improved various aspects of on-demand transportation, including algorithms for pairing providers with requestors for transport. Unfortunately, computational models of conventional ride-sharing systems exhibit technical limitations that lead to increased system latency between receiving transportation requests and the pairing of providers and requestors. In addition to system latency, computational models of conventional ride-sharing systems also lack the algorithmic flexibility to adjust or improve (e.g., decrease) an estimated time to arrival (ETA) of a provider vehicle at a pickup location for a requestor.

As suggested above, conventional computational models of conventional ride-sharing systems often increase system latency by imposing a pooling time window for pairing a requestor with a provider. During this pooling time window, conventional computational models pool together a group of unassigned providers in a geographic area and a group of outstanding transportation requests for the geographic area yet to be assigned. Based on one or more conventional pairing algorithms, conventional ride-sharing systems can transmit an assignment for a transportation request to an unassigned provider only after the pooling time window expires. As on-demand transportation advances, such system latency of conventional ride-sharing systems has become an excessive delay for many requestors, particularly in time sensitive circumstances.

In addition to system latency, conventional ride-sharing systems utilize pairing algorithms that are too rigid of an approach to efficiently match some requestors. Indeed, conventional ride-sharing systems rigidly limit a set of providers (e.g., a pool of unassigned providers mentioned above) using conventional algorithms that treat transportation requests in a uniform manner. In turn, conventional ride-sharing systems inflexibly provide little choice to requestors but to accept an ETA to the pickup location (among other transportation terms), or else cancel/edit the transportation request. Of course, requestors can schedule a ride for a later date and/or time. But for on-demand transportation, computational models of conventional ride-sharing systems employ pairing algorithms that generally have a one-size-fits-all approach to arrival times for pickup.

### BRIEF SUMMARY

This disclosure describes one or more embodiments of methods, non-transitory computer-readable media, and systems that solve the foregoing problems in addition to providing other benefits. In particular, the disclosed systems can identify provider devices and corresponding vehicles as candidates to transport time-sensitive (or otherwise prioritized) requestors and provide prioritized transportation options as fast passes for display on such requestors' devices. To provide such a prioritized transportation option, the disclosed systems can identify provider devices either matched or unmatched with requestors as candidates for prioritized transport based on estimated times of arrivals (ETAs) of vehicles for the candidate provider devices at the requestor's pickup location. Based on the ETAs at the pickup location, the disclosed systems can select a closest provider device from among the candidate provider devices to transport a prioritized requestor.

For example, the disclosed systems can give priority to a particular requestor over other requestors (for standard transportation options) to surface a prioritized transportation option for the closest provider device on the requestor's device. If the closest provider device is already en route in a vehicle to another requestor, in some cases, the disclosed systems can rematch the closest provider device to the prioritized requestor over a previously matched requestor. After matching the prioritized requestor to the closest provider device, the disclosed systems can further search for providers with sooner ETAs. If another provider comes online with a sooner ETA than the closest provider, the disclosed systems can switch (e.g., rematch) provider devices for quicker pickup of the prioritized requestor. Accordingly, in some cases, the disclosed systems reassign matched provider devices from (i) traveling to pick up a previously matched requestor or transporting the previously matched requestor to (ii) instead (or also) pick up a prioritized requestor and provide a shorter ETA in a fast pass to the prioritized requestor.

### BRIEF DESCRIPTION OF THE DRAWINGS

The detailed description refers to the drawings briefly described below.

FIG. 1 illustrates a schematic diagram of a computing system environment for implementing a priority management system in accordance with one or more embodiments.

FIG. 2 illustrates a priority management system selecting a provider device from among candidate provider devices for prioritized transport of a requestor and providing a prioritized transportation option to a requestor device for prioritized transport of the requestor by the selected provider device in accordance with one or more embodiments.

FIG. 3 illustrates a priority management system determining to provide or remove a prioritized transportation option for display at a requestor device in accordance with one or more embodiments.

FIGS. 4A-4F illustrate a sequence diagram of a priority management system selecting a provider device from among candidate provider devices for prioritized transport of a requestor and providing a prioritized transportation option to a requestor device for prioritized transport of the requestor by the selected provider device in accordance with one or more embodiments.

FIG. 5A illustrates a schematic configuration of transportation vehicles and requestors for which the priority management system generates transportation plans in accordance with one or more embodiments.

FIGS. 5B-5C illustrate respective process flows for a priority management system generating matching scores for potential transportation plans in accordance with one or more embodiments.

FIGS. 6A-6D illustrate a computing device presenting graphical user interfaces relating to a prioritized transportation option in accordance with one or more embodiments.

FIG. 7 illustrates a graph indicating testing results of a priority management system improving an estimated time of arrival metric in accordance with one or more embodiments.

FIG. 8 illustrates a graph indicating testing results of a priority management system when implementing prioritized transportation options during busy or premium-priced time periods in accordance with one or more embodiments.

FIG. 9 illustrates an example schematic diagram of a priority management system in accordance with one or more embodiments.

FIG. 10 illustrates a flowchart of a series of acts for selecting a provider device from among candidate provider devices for prioritized transport of a requestor and providing a prioritized transportation option in accordance with one or more embodiments.

FIG. 11 illustrates a block diagram of an example computing device for implementing one or more embodiments of the present disclosure.

FIG. 12 illustrates an example network environment of a transportation matching system in accordance with one or more embodiments.

### DETAILED DESCRIPTION

This disclosure describes one or more embodiments of a priority management system that selects a provider device from among candidate provider devices for prioritized transport of a requestor and dynamically provides a prioritized transportation option as a fast pass to the requestor's computing device for fast transport from pickup to drop-off locations. For example, the priority management system can identify a pickup location for a requestor's device based on a geographic location of the device or user input into the device. To select a provider device for prioritized transport, the priority management system can identify an expanded pool of provider devices for a fast-pass requestor—including (i) unassigned provider devices currently waiting for requestor assignments and (ii) assigned provider devices either en route to pickup locations of assigned requestors or transporting assigned requestors to destination locations. Based on respective estimated time to arrival (ETA) to a pickup location of the fast-pass requestor, the priority management system can select the provider device to quickly pickup and transport the fast-pass requestor, such as by selecting the provider device having the shortest ETA at the pickup location. Upon selecting a provider device, the priority management system provides a prioritized transportation option for prioritized transport of the fast-pass requestor for display on the requestor's device.

As mentioned above, the priority management system can determine candidate provider devices for prioritized transport of a requestor. In particular, the priority management system can determine the locations of provider devices that are within a threshold ETA at a pickup location for the requestor. Alternatively, the priority management system may identify provider devices that are positioned within a threshold distance to the pickup location for the requestor or within a same geocoded region or geocoded area as the pickup location for the requestor. The priority management system can group these or other provider devices as candidate provider devices for prioritized transport of the requestor. As noted above, the candidate provider devices for prioritized transport may include (i) unassigned provider devices not associated with requestors and (ii) assigned provider devices either traveling to or transporting requestors. The priority management system can assign (or reassign) any one of the candidate provider devices to pick up the requestor at the pickup location.

For example, as part of a ghost-matching process prior to receiving a transportation request from the requestor, the priority management system may select one of the candidate provider devices for prioritized transport of the requestor. In particular, the priority management system may select a candidate provider device having an earlier ETA at the pickup location than other candidate provider devices. In some cases, the priority management system may select a candidate provider device having an earliest ETA at the pickup location compared to other candidate provider devices. Accordingly, unlike standard transportation options, the priority management system can reassign (e.g., steal) a provider device from a standard transportation assignment to provide a prioritized transportation option with earlier ETAs. To offer an earlier ETA to a prioritized requestor, for example, the priority management system may select a previously assigned provider device for a prioritized transportation option by (i) selecting a provider device en route to a pickup location of a previously assigned requestor associated with a standard or shared transportation option, (ii) converting an assignment of a provider device from a solo transport of a previously assigned requestor to a shared transport with a prioritized requestor, or (iii) rerouting a provider device assigned to a shared transport to also pick up a prioritized requestor.

In addition to accounting for ETA, the priority management system may select one of the candidate provider devices for prioritized transport of the requestor based on matching scores associated with potential transportation plans. A potential transportation plan includes possible transportation arrangements or combinations of providers and/or requestors that the priority management system assesses based on matching scores. In particular, the priority management system can generate matching scores for potential transportation plans based on prioritization factors that boost or penalize potential transportation plans. To ensure selection of a candidate provider device with an earlier (or earliest) ETA among the candidate provider devices, in some embodiments, the priority management system provides a prioritization factor that boosts the matching score of transportation plans comprising the prioritized transport of the requestor. In addition, the priority management system can use penalizing factors for a matching score to penalize transportation plans that will likely reduce throughput or cause negative experiences for providers or other requestors (e.g., increased travel time, increased ETA, multiple swaps).

After selecting a candidate provider device for prioritized transport of the requestor, the priority management system can provide a prioritized transportation option for display on a requestor device. The prioritized transportation option may include a selectable toggle or selectable transportation mode. Additionally, the prioritized transportation option may include prioritized pickup information indicating differences between the prioritized transportation option and a standard transportation option. For example, the priority management system can surface an ETA differential that indicates a difference between ETAs at the pickup location for transportation vehicles according to a standard transportation option and the prioritized transportation option. Similarly, the priority management system can surface a price differential that indicates a difference between a standard cost for the standard transportation option and a premium cost for the prioritized transportation option. Additionally, in some embodiments, the priority management system surfaces at least one of a provider indicator associated with a provider device or a graphical representation of a mapped route for the transportation vehicle to travel to the pickup location.

In these or other embodiments, the priority management system can limit when (and to which requestor devices) the priority management system provides the prioritized transportation option. For example, the priority management system may limit availability of the prioritized transportation option based on requestor profile data (e.g., user preferences, historical transportation requests, calendar events that indicate a likelihood of the requestor requesting prioritized transport). As another example, the priority management system may limit availability of the prioritized transportation option based on a dynamic conversion metric (e.g., a number of providers out of a threshold number of providers currently providing prioritized transport of requestors). Moreover, the priority management system can iteratively assess whether to provide a prioritized transportation option to a requestor device (e.g., by iteratively determining candidate provider devices, updated matching scores, an updated dynamic conversion metric). Based on one or more iterative (or initial determinations described above), the priority management system may choose not to provide a requestor device a prioritized transportation option. Accordingly, the priority management system can remove (and in some cases re-surface) a prioritized transportation option for display in an ephemeral manner at the requestor device based on such iterative determinations.

After initially selecting a provider device for prioritized transport of a requestor, the priority management system can continue to search for candidate provider devices with an earlier ETA than the initially selected provider device. In some cases, the priority management system continues to search for a candidate provider device with an earlier ETA until the initially selected provider device is within a threshold time or distance of the pickup location. In particular embodiments, the priority management system may identify a newly available provider device corresponding to newly available transportation vehicle having an earlier ETA at the pickup location. Based on identifying a newly available provider device having an earlier ETA, the priority management system may send a matched transportation assignment to the newly available provider device for the newly available transportation vehicle to pick up the requestor at the pickup location. In addition, the priority management system may send a notification to the provider device initially selected for the prioritized transport of the requestor to not pick up the requestor.

As suggested above, the priority management system provides a number of technical advantages over conventional ride-sharing systems. For example, the priority management system can expand the pool of provider devices into a more flexible set of candidates for prioritized transport than conventional ride-sharing systems or conventional transportation options. Whereas conventional ride-sharing systems can only consider unassigned providers for matching with requestors, the priority management system can leverage an expanded supply pool of candidate provider devices for prioritized transport of a requestor and improved ETAs for such a prioritized requestor. For example, the priority management system can identify and expand candidate provider devices for a prioritized transportation option to include unassigned provider devices waiting for a transportation assignment as well as assigned provider devices that are initially or currently assigned to another requestor. Thus, in some cases, the priority management system can reassign (e.g., steal) provider devices from the expanded pool of provider devices including provider devices engaged in in-transit-to-pickup status or active-transport status. To illustrate the expanded pool for prioritized transport, the priority management system can select a previously assigned provider device for a prioritized transportation option by (i) identifying a provider device en route to a pickup location of a previously assigned requestor associated with a standard or shared transportation option, (ii) converting an assignment of a provider device from a solo transport of a previously assigned requestor to a shared transport with a prioritized requestor, or (iii) rerouting a provider device assigned to a shared transport to also pick up a prioritized requestor.

Even after initially providing a transportation assignment (or reassignment) to a candidate provider device for prioritized transport, the priority management system can switch transportation assignments to a different candidate provider device (e.g., an unassigned provider device) with a shorter ETA. Accordingly, the priority management system does not guarantee a specific provider or provider device for a prioritized transportation option, but can switch to other candidate or newly available provider devices. With more candidate provider devices to choose from, the priority management system can more flexibly compare ETAs to determine a candidate provider device best suited for prioritized transport of the requestor. Unlike the rigid approach of conventional ride-sharing systems, the priority management system can surface more transportation options to requestor devices heretofore unavailable, including a prioritized transportation option for a faster pickup compared to a standard transportation option.

In addition to improved system flexibility, the priority management system can use a computational model that (i) matches a likely transportation requestor to a candidate provider device based on a detected pickup location and (ii) surfaces a real-time transportation option faster than conventional ride-sharing systems. In certain implementations, the priority management system generates a “ghost” match in response to detecting a pickup location associated with requestor device rather than in response to receiving a completed, transportation request. By utilizing this ghost-matching approach, the system introduces a dynamic computational model that allows for instantaneous matching of requestors and real-time surfacing of prioritized transportation options. Thus, the priority management system avoids the problems common to the slow and rigid computational models utilized by conventional ride-sharing systems that match a received transportation request to a provider only after the delay of a pooling time window for matching. By avoiding the latency of such a pooling time window, the priority management system expedites the computing to match a prioritized requestor. As described below, in some embodiments, the priority management system implements an ordered combination of steps using unconventional rules to do what conventional ride-sharing systems cannot—that is, extemporaneously provide (or remove) for display a prioritized transportation option at a requestor device in an ephemeral manner.

As suggested above, in certain implementations, the priority management system ghost matches a prioritized requestor with a specific provider associated with (i) a candidate provider device currently in transit to pick up another requestor instead of (ii) a candidate provider device idling and waiting to receive transportation requests. By selecting a provider device in an in-transit-to-pickup status with a faster ETA than a provider device in an idle status, the priority management system can assign (and display with a prioritized transportation option) a specific provider more certain to accept a prioritized transportation request from a prioritized requestor's device. Because a provider device in in-transit-to-pickup status previously accepted a transportation request from another requestor device—and a provider device in idle status is more likely to reject or allow a transportation request to lapse (e.g., expire)—the provider device in in-transit-to-pickup status provides a more certain and specific provider to display with a prioritized transportation option before receiving a request from a prioritized requestor's device. In some cases or geographic areas, a provider device in idle status accepts about 80% (or rejects about 20%) of transportation requests, making a provider associated with such an idle provider device a less certain provider to display for a prioritized transportation option. Therefore, by selecting a provider device in in-transit-to-pickup status rather than idle status for a prioritized transportation option—and reducing a number of underutilized provider devices idling and awaiting transportation requests to maintain target ETAs—the priority management system increases the certainty of selecting and showing a specific provider to prioritized requestor devices before receiving prioritized transportation requests, expedites ETAs at a prioritized requestors' pickup locations with closer providers, and more efficiently utilizes a pool of candidate provider devices for a geographic area.

In certain embodiments, the priority management system also presents a prioritized transportation option in real-time by integrating location and position data from global positioning system (GPS) devices. Because of this real-time integration of location and position data, the priority management system can determine candidate provider devices for prioritized transport of a requestor. As mentioned above, some conventional ride-sharing systems rigidly execute static computational models to match new requestors only after a transportation request is received and after expiration of a pooling time window. In contrast to such conventional ride-sharing systems, in certain embodiments, the priority management system utilizes GPS signals and other data from a requestor device in connection with real-time location and GPS data of candidate provider devices associated with nearby transportation vehicles to ghost-match the requestor prior to receiving a transportation request. Additionally, given the dynamic, movable nature of candidate provider devices associated with transportation vehicles, in some cases, acquiring real-time GPS signals from GPS devices of candidate provider devices is integral to selecting a candidate provider device with an earliest ETA at the pickup location for prioritized transport of the requestor—all prior to receiving a transportation request from the requestor.

As illustrated by the foregoing discussion, the present disclosure utilizes a variety of terms to describe features and advantages of the priority management system. For example, as used herein, the term “transportation request” refers to a request from a requesting individual (i.e., a requestor) for transport by a transportation vehicle. In particular, a transportation request can include a request by a requestor device or a transportation matching system for a transportation vehicle to transport a requestor or a group of individuals from one geographic area to another geographic area.

In some embodiments, a transportation request can include data associated with a requestor device, including a request location (e.g., a location from which the transportation request is initiated), a destination (e.g., a location to which the requestor wishes to travel), a pickup location and a drop-off location where a requestor can be respectively picked up for transportation and dropped off from transportation (which geographic areas may be the same as or different from the request location and destination), location profile information, a requestor rating, a travel history, a search history, etc. Additionally, or alternatively, a transportation request can include a request to be transported in certain manner (e.g., according to a service category type such as standard, premium, luxury, shared, shared saver, wheel-chair accessible). Based on a transportation request, for instance, the priority management system can generate, transmit, and/or assign a transportation assignment (e.g., instructions for a provider device to pick up a requestor at a pickup location, and transport the requestor to a drop-off location).

As further used herein, the term “prioritized transportation option” refers to an option presented on or provided to a requestor device for a vehicle to transport a requestor with a prioritized pickup or drop-off. In particular, a prioritized transportation option can include an option for prioritized transport in the form of a faster pickup that reduces requestor waiting time prior to pick up in comparison to a standard transportation option. In certain embodiments, a prioritized transportation option can include a selectable-user-interface element or service category type for indicating a transportation request is urgent or important to a requestor. This disclosure sometimes refers to a prioritized transportation option displayed on a client device or accepted by user selection as a fast pass. In one or more implementations, a prioritized transportation option includes a selectable toggle with corresponding information for a prioritized transport (e.g., transportation by a transportation vehicle according to the prioritized transportation option). For example, a prioritized transportation option may include a provider indicator (e.g., a picture, name, and/or vehicle make/model associated with a provider). As another example, a prioritized transportation option may include a graphical representation of a mapped route (e.g., a digital depiction of a possible path of travel) for a transportation vehicle associated with a selected provider device to traverse en route to a pickup location.

As further used herein, the term “transportation plan” refers to an arrangement or combination of a requestor and/or a provider in a transportation matching process. In particular, a transportation plan can include one of several possible combinations of requestors and providers (or an unpaired requestor or unpaired provider) for a particular geographic region and time frame. For example, a transportation plan can include leaving an individual requestor or provider unassigned (or unmatched). As another example, a transportation plan can include pairing a prioritized requestor and a provider currently en route to another pickup location in accordance with a current transportation assignment. In these or other embodiments, the priority management system can generate matching scores (e.g., numerical evaluations based on ETA and other factors) for each transportation plan.

Relatedly, the term “prioritization factor” refers to a weighting value for generating matching scores. In particular, a prioritization factor can boost (e.g., increase) or penalize (e.g., decrease) a matching score for a given transportation plan. For example, the priority management system may generate a boosting prioritization factor for transportation plans that include a requestor associated with a prioritized transportation option. As another example, the priority management system may generate a penalizing prioritization factor for transportation plans that reduce throughput or cause a negative user experience for a requestor/provider.

As suggested above, the term “transportation provider” (or simply “provider”) refers to a driver or other person who operates a transportation vehicle and/or who interacts with a provider device, on the one hand, or artificial intelligence or algorithm that (upon execution) operates an autonomous vehicle, on the other hand. For instance, a transportation provider includes a person who drives a transportation vehicle along various transportation routes—or artificial intelligence for an autonomous vehicle that drives along such transportation routes—to pick up and drop off requestors. Accordingly, in some embodiments, a provider may include software and/or artificial intelligence on a provider device that, when executed, operates a transportation vehicle (e.g., a semi-autonomous or fully-autonomous vehicle) in accordance with transportation assignments.

Further, the term “geocoded region” (or simply “region”) refers to a spatial division or unit of a larger geographic space. For instance, in some embodiments, a region refers to a city, a collection of cities, or a portion of a city. Such regions may include, for example, Chinatown of San Francisco, Calif.; San Francisco, Calif.; or one or more of the Boroughs of New York City, N.Y. As described below, a region includes a collection of geocoded areas.

Relatedly, the term “geocoded area” refers to a spatial subdivision or subunit of a region or a larger geographic space. A geocoded area may be a subdivision of a geographic neighborhood as well as a subdivision of a city. As a subdivision, a geocoded area may include a segment of a street, a street, a set of bordering streets, a city block, a set of city blocks, or another portion of an area within a larger geographic space. For example, a set of bordering streets may define a geocoded area within a larger space, such as a set of streets around Times Square in New York City, N.Y. In certain embodiments, a geocoded area represents a geographic hash (“geohash”) in a grid (or other polygon shape) of geohashes within a larger geographic space. Regardless of the form of a geocoded area, one or more requestors or providers may be located within a geocoded area.

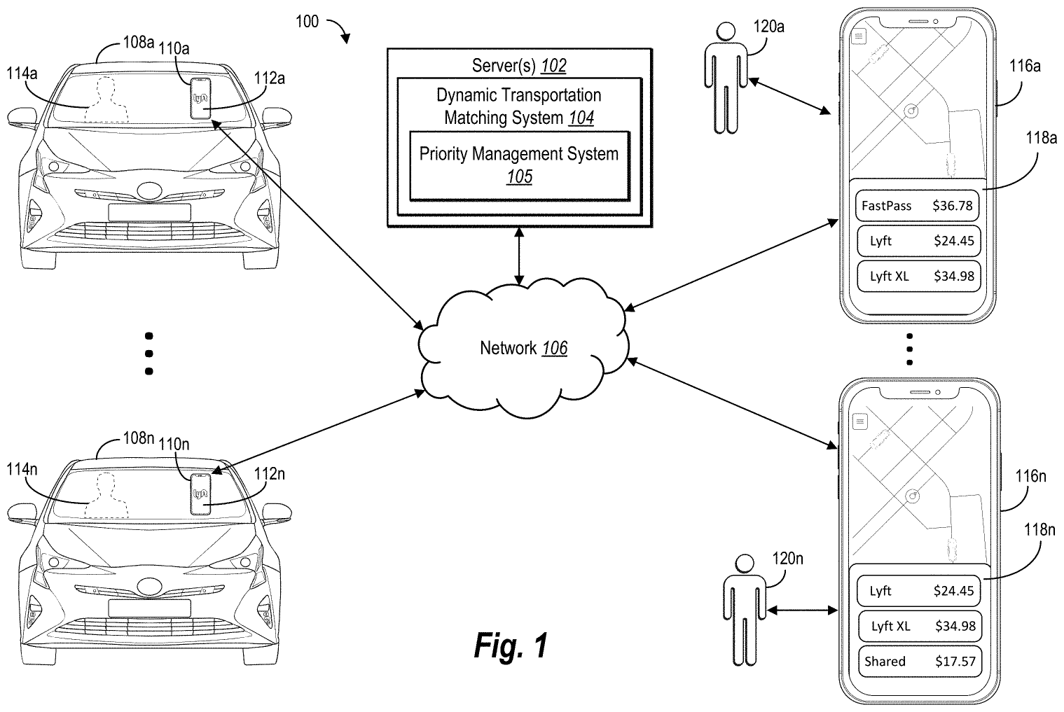

Turning now to the figures, FIG. 1 illustrates a schematic diagram of a computing environment (or “environment”) 100 for implementing a priority management system 105 in accordance with one or more embodiments. As shown in FIG. 1, the environment 100 includes server(s) 102 comprising a dynamic transportation matching system 104 and the priority management system 105, transportation vehicles 108a-108n, provider devices 110a-110n respectively corresponding to the transportation vehicles 108a-108n, requestor devices 116a-116n respectively corresponding to requestors 120a-120n, and a network 106. In some embodiments, the transportation vehicles 108a-108n optionally include respective providers 114a-114n. The providers 114a-114n in this example are human providers associated with both the transportation vehicles 108a-108n and the provider devices 110a-110n, respectively.

As shown, in one or more embodiments, the priority management system 105 can be a component of the dynamic transportation matching system 104 implemented on one or more of the server(s) 102. In these or other embodiments, the priority management system 105 may perform one or more acts of the present disclosure described in conjunction with the dynamic transportation matching system 104. Additionally, or alternatively, the dynamic transportation matching system 104 may perform one or more acts of the present disclosure described in conjunction with the priority management system 105. Furthermore, although FIG. 1 depicts the priority management system 105 and the dynamic transportation matching system 104 as distinct systems, the priority management system 105 can be implemented in whole or in part by the dynamic transportation matching system 104, and vice-versa.

As indicated by FIG. 1, the dynamic transportation matching system 104 uses the server(s) 102 to communicate with one or both of the provider devices 110a-110n and the requestor devices 116a-116n via the network 106. For example, the dynamic transportation matching system 104 communicates with the provider devices 110a-110n and the requestor devices 116a-116n via the network 106 to determine locations (e.g., real-time GPS locations) of the provider devices 110a-110n and the requestor devices 116a-116n, respectively. Per device settings, for instance, the dynamic transportation matching system 104 may receive location coordinates from the provider devices 110a-110n and/or the requestor devices 116a-116n, respectively. Based on the location coordinates, the dynamic transportation matching system 104 matches or assigns one or more of the transportation vehicles 108a-108n with one or more of the requestors 120a-120n for transportation.

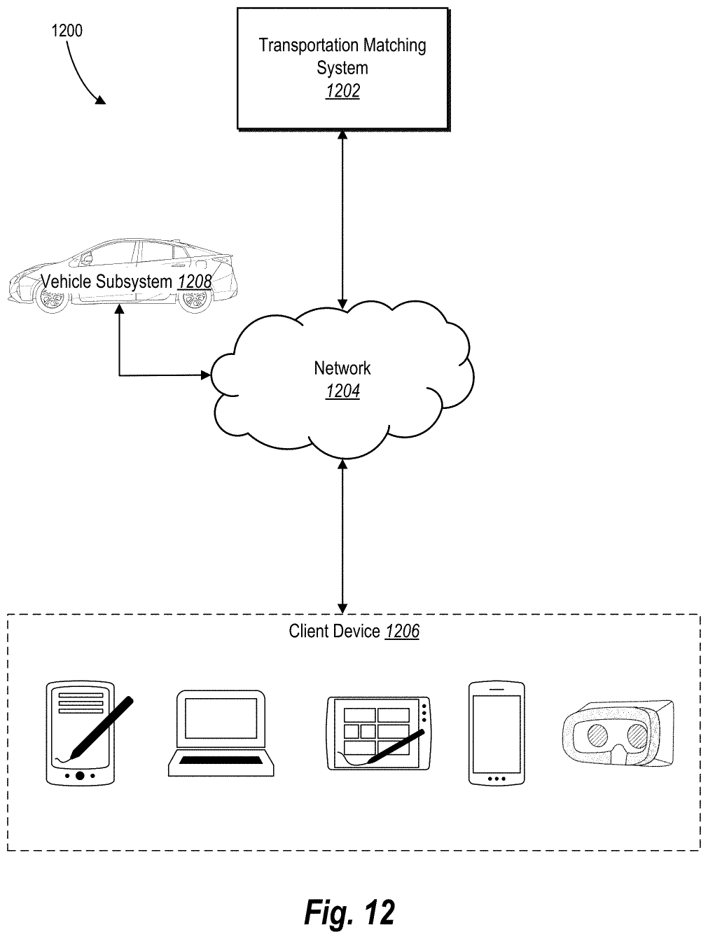

As suggested above, each of the provider devices 110a-110n and the requestor devices 116a-116n may comprise a mobile device, such as a laptop, smartphone, or tablet associated with a requestor or a provider. The provider devices 110a-110n and the requestor devices 116a-116n may be any type of computing device as further explained below with reference to FIG. 12. In some embodiments, one or more of the provider devices 110a-110n are not associated with human providers, but are attached to (or integrated within) the transportation vehicles 108a-108n, respectively.

As further indicated by FIG. 1, the provider devices 110a-110n include provider applications 112a-112n, respectively. Similarly, the requestor devices 116a-116n include requestor applications 118a-118n, respectively. In some embodiments, the provider applications 112a-112n (or the requestor applications 118a-118n) comprise web browsers, applets, or other software applications (e.g., native applications) respectively available to the provider devices 110a-110n or the requestor devices 116a-116n. Additionally, in some instances, the dynamic transportation matching system 104 provides data including instructions that, when executed by the provider devices 110a-110n or by the requestor devices 116a-116n, respectively create or otherwise integrate one of the provider applications 112a-112n or the requestor applications 118a-118n with an application or webpage.

As indicated by FIG. 1, a requestor may use a requestor application to request transportation services, receive a price estimate for the transportation service, edit a transportation request, and access other transportation-related services. For example, the requestor 120a may interact with the requestor device 116a through graphical user interfaces of the requestor application 118a to select a prioritized transportation option. After receiving an indication of the selected prioritized transportation option, the priority management system 105 may provide an updated prioritized transportation option with additional prioritized transport information. For example, the priority management system 105 may provide, for display within the requestor application 118a, a provider indicator identifying a selected provider for prioritized transport of the requestor 120a, a graphical representation of a mapped route between the selected provider and a pickup location), or other graphical components as described below. Based on the updated prioritized transportation option, the requestor 120a can submit (i.e., request), edit, or cancel the prioritized transportation option. In other embodiments, the priority management system 105 may not provide a prioritized transportation option for display within a requestor application (e.g., as shown for the requestor application 118n)—depending on a location of the requestor device, availability of provider devices and corresponding vehicles, and/or a history of a corresponding requestor.

As further depicted in FIG. 1, the dynamic transportation matching system 104 assigns transportation requests from one or more of the requestor devices 116a-116n to one or more of the provider devices 110a-110n within the transportation vehicles 108a-108n, respectively. While FIG. 1 depicts the transportation vehicles 108a-108n as automobiles, a transportation vehicle may also be an airplane, bicycle, motorcycle, scooter, or other vehicle. In some cases, this disclosure describes a transportation vehicle as performing certain functions, but such a transportation vehicle includes an associated provider device that often performs a corresponding function. For example, when the dynamic transportation matching system 104 sends a transportation request to the transportation vehicle 108a—or queries location information from the transportation vehicle 108a—the dynamic transportation matching system 104 sends the transportation request or location query to the provider device 110a. Accordingly, the transportation vehicle 108a and the provider device 110a are part of a vehicle subsystem in one or more implementations.

Although not illustrated in FIG. 1, in some embodiments, the environment 100 may have a different arrangement of components and/or may have a different number or set of components altogether. In certain implementations, for instance, some or all of the transportation vehicles 108a-108n do not include a human provider, but constitute autonomous transportation vehicles—that is, a self-driving vehicle that includes computer components and accompanying sensors for driving without manual-provider input from a human operator. As a further example, in some embodiments, one or more of the transportation vehicles 108a-108n include a hybrid self-driving vehicle with both self-driving functionality and some human operator interaction.

When a transportation vehicle is an autonomous vehicle or a hybrid self-driving vehicle, the transportation vehicle may include additional components not depicted in FIG. 1. Such components may include location components, one or more sensors by which the autonomous vehicle navigates, and/or other components necessary to navigate without a provider (or with minimal interactions with a provider). Regardless of whether a transportation vehicle is associated with a provider, a transportation vehicle can include a locator device, such as a GPS device, that transmits the location of the transportation vehicles 108a-108n.

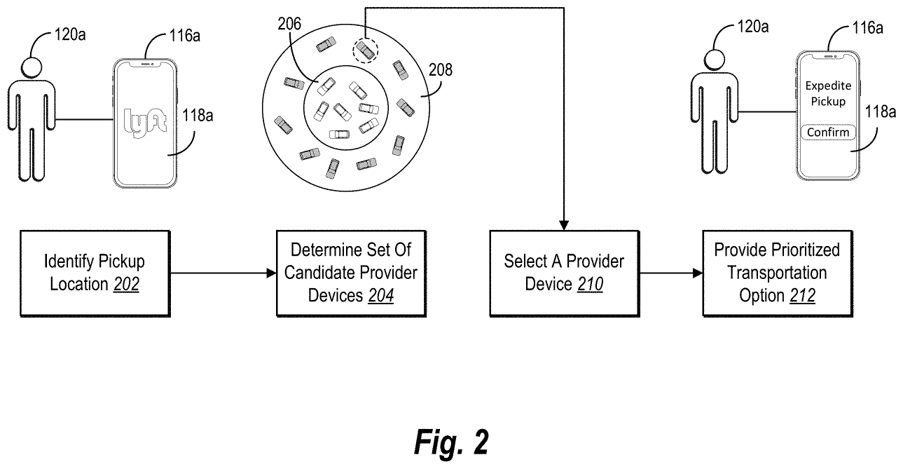

As mentioned above, the priority management system 105 can provide a prioritized transportation option to a requestor device for expedited pickup. In accordance with one or more embodiments, FIG. 2 illustrates the priority management system 105 selecting a provider device from among candidate provider devices for prioritized transport of a requestor and providing a prioritized transportation option to a requestor device for prioritized transport of the requestor by the selected provider device. As described more below, the priority management system 105 utilizes a pickup location as a basis for determining which candidate provider device can quickly provide prioritized transport for the requestor via an associated transportation vehicle. Based on the priority management system 105 identifying a particular candidate provider device, the priority management system 105 can surface a prioritized transportation option specific to the requestor device.

As shown in FIG. 2, the priority management system 105 can identify a pickup location at act 202. To do so, the priority management system 105 can detect, query, or otherwise obtain location data of the requestor device 116a associated with the requestor 120a. For example, when the requestor device 116a accesses the requestor application 118a, the requestor application 118a may cause the requestor device 116a to transmit real-time GPS location data to the priority management system 105. Additionally or alternatively, the priority management system 105 may send a location request to the requestor device 116a (e.g., in response to the requestor device 116a accessing the requestor application 118a). Further, in some embodiments, the priority management system 105 receives, from the requestor device 116a, user input indicating a pickup location.

In other cases, the priority management system 105 at act 202 may send a location request to the requestor device 116a at predetermined time intervals (e.g., when background location tracking is enabled at the requestor device 116a). In yet another embodiment, the priority management system 105 may identify a pickup location by analyzing user activity, such as calendar events, digital communications, real-time GPS data from the requestor device 116a to predict where and when the requestor device 116a will submit a transportation request (e.g., based on historical user activity).

Based on the identified pickup location at act 202, the priority management system 105 can determine a set of candidate provider devices at act 204. As shown in FIG. 2, the set of candidate provider devices can comprise different sets of candidate provider devices, including unassigned provider devices 206 and assigned provider devices 208. The unassigned provider devices 206 are provider devices that are unassigned to pick up or transport a requestor and waiting for a transportation assignment for a particular requestor. In contrast, the assigned provider devices 208 are provider devices that are currently assigned to another requestor device to pick up or transport a requestor (e.g., according to a standard transportation option, a shared ride option) but have not yet performed pickup according to a current transportation assignment.

To determine the unassigned provider devices 206 and the assigned provider devices 208, the priority management system 105 can detect, query, or otherwise obtain location data of provider devices that are online (e.g., logged into a provider application) and positioned within a geographic region. For instance, using real-time GPS data from the provider devices, the priority management system 105 can selectively identify a set of provider devices within a threshold distance (e.g., a 1-mile radius) and/or a threshold ETA relative to the identified pickup location at act 202. Additionally or alternatively, the priority management system 105 may selectively identify a set of provider devices positioned within a same geocoded region or geocoded area as the identified pickup location for the requestor.

In addition, the priority management system 105 can determine the unassigned provider devices 206 and the assigned provider devices 208 by identifying a transportation-assignment status of the set of provider devices. For example, the priority management system 105 may identify a provider device as having an idle status in which the provider device is online but without assignment to a requestor, an in-transit-to-pickup status in which the provider device is assigned to a requestor without pickup completed, or an active-transport status in which the provider device is assigned to a requestor with pickup completed. In certain implementations, the priority management system 105 utilizes transportation-assignment statuses of finer granularity. For instance, the priority management system 105 may further breakdown the provider devices having an in-transit-to-pickup status into various subsets of providers (e.g., by different amounts or percentages of travel time/distance completed, by different amounts or percentages of travel time/distance remaining to pick up). Thus, in some embodiments, the priority management system 105 utilizes real-time GPS data to determine where provider devices in in-transit-to-pickup status are specifically located relative to their currently assigned pickup location.

Based on the identified transportation-assignment statuses of the set of provider devices, the priority management system 105 can filter or exclude certain provider devices from the set of candidate provider devices for prioritized transport of the requestor 120a. For example, the priority management system 105 can exclude provider devices having an active-transport status. As another example, the priority management system 105 can filter out provider devices having an in-transit-to-pickup status indicating an ETA of less than 120 seconds to a currently assigned pickup location or a remaining distance (e.g., a haversine distance) of less than 400 meters away from the currently assigned pickup location.

Utilizing real-time GPS data of provider devices for this selective filtering, the priority management system 105 can dynamically and accurately determine the candidate provider devices comprising the unassigned provider devices 206 and the assigned provider devices 208. By determining the candidate provider devices as just described, the priority management system 105 can significantly improve system flexibility to select a provider device with the fastest ETA at the identified pickup location for the requestor 120a.

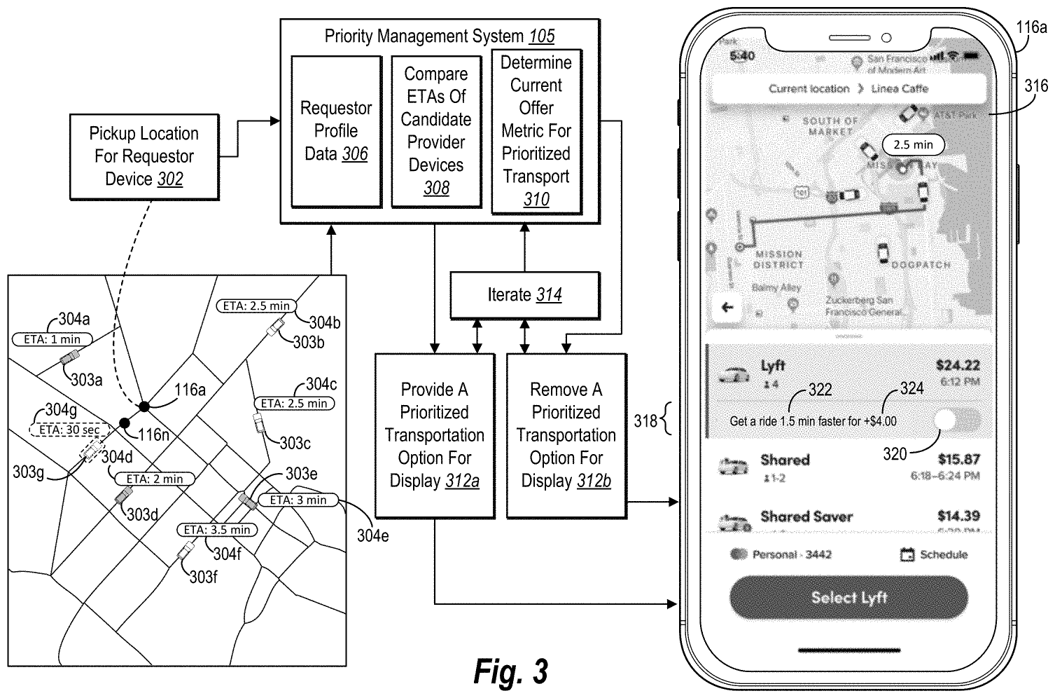

As further shown at act 210 in FIG. 2, for example, the priority management system 105 can compare ETAs of the candidate provider devices (e.g., as described more below in relation to FIG. 3) to select a candidate provider device for prioritized transport of the requestor 120a. In these or other embodiments, the priority management system 105 selects one of the unassigned provider devices 206 or the assigned provider devices 208. In some cases, the priority management system 105 prioritizes selection of the unassigned provider devices 206 over the assigned provider devices 208. In particular embodiments, the priority management system 105 selects one of the candidate provider devices as part of a ghost-matching process prior to receiving an actual transportation request from the requestor device 116a. That is, prior to act 212, the priority management system 105 in one or more implementations has already selected a discrete candidate provider device for providing prioritized transport of the requestor 120a.

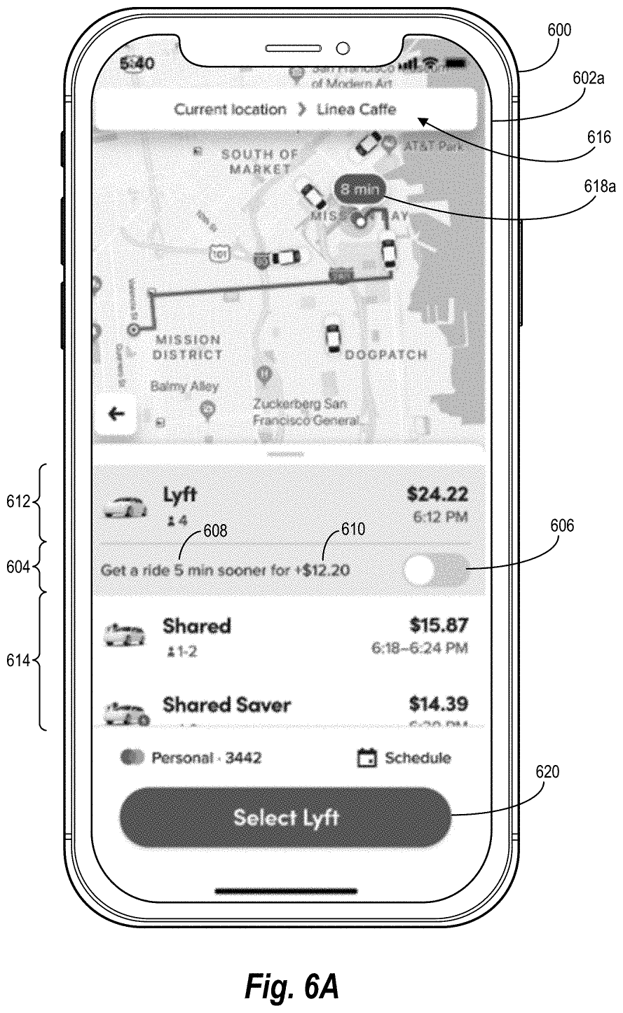

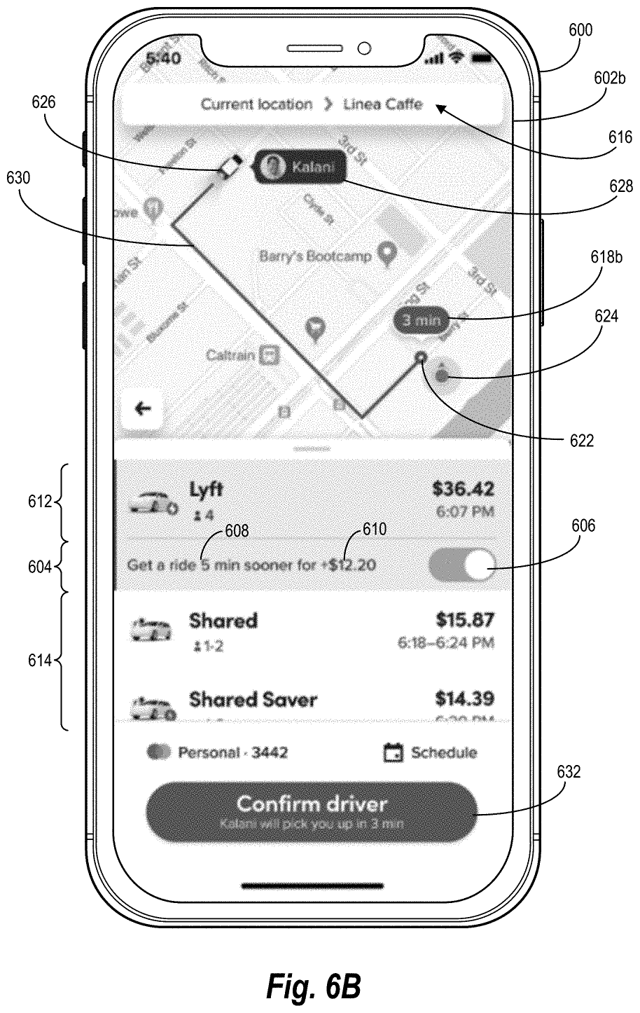

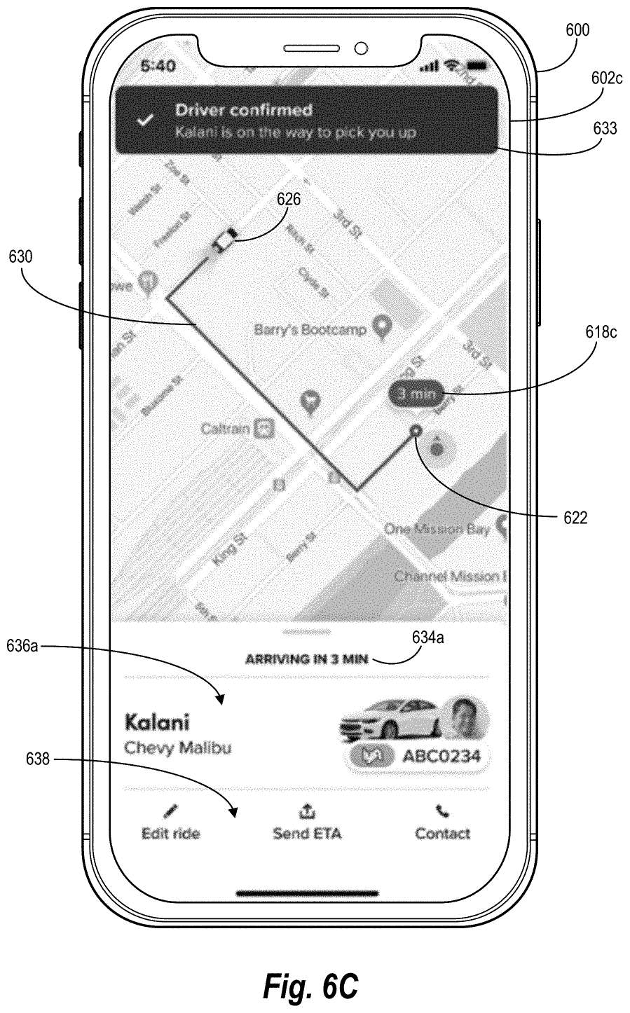

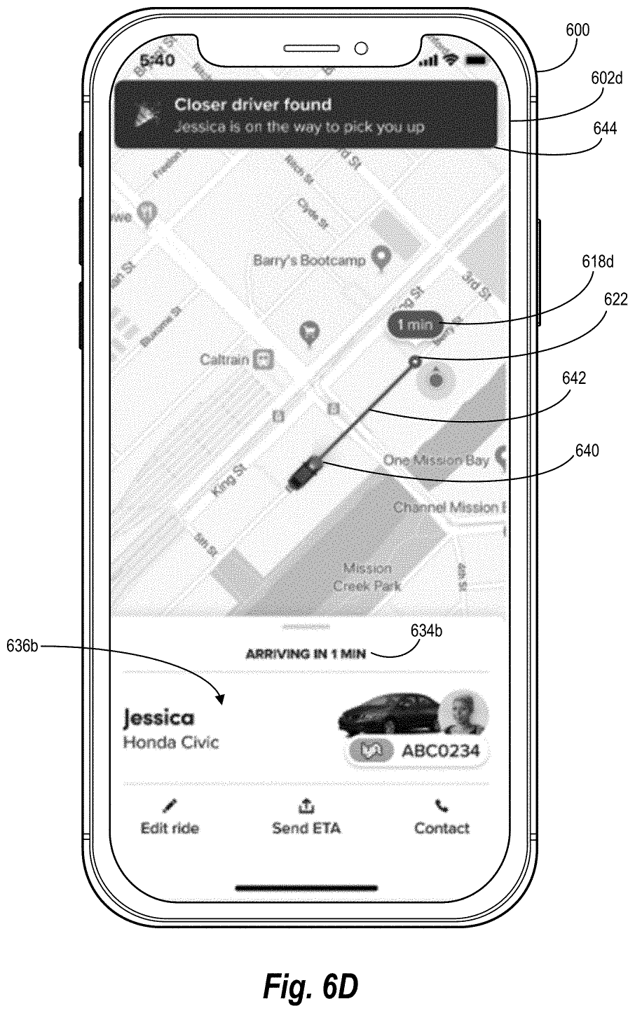

After selecting a provider device from among candidate provider devices, the priority management system 105 can provide a prioritized transportation option to the requestor device 116a at act 212. In particular, the priority management system 105 can, pre-request, surface the prioritized transportation option at the requestor device 116a (e.g., in response to detecting the requestor device 116a access the requestor application 118a, in response to receiving an indication of a destination location). In these or other embodiments, the priority management system 105 may cause the requestor device 116a to display the prioritized transportation option with the selected candidate provider device. Otherwise, in some embodiments, the priority management system 105 can cause the requestor device 116a to update the prioritized transportation option with the selected candidate provider device after receiving confirmation of the prioritized transportation option. Additional detail regarding the prioritized transportation option is described further below in relation to FIGS. 3 and 6A-6D.

In general, however, a prioritized transportation option can be particularly useful for requestors in a variety of use cases. For example, when a requestor is late for a 9:30 am flight or meeting, ETAs of vehicle to a requestor's location can be high. In this case, the requestor may wish to pay a larger fare for expedited pickup to make the flight or meeting. As another example, a requestor may be required to travel for business. The employer may therefore wish to pay a larger fare so that the requestor can maximize productivity outside of the transportation. In yet another example, a requestor may be leaving a popular, high-density event (e.g., concert, festival, sporting event, club) associated with long and variable ETAs. The requestor in this instance may wish to pay a premium for expedited pickup out of the venue. The prioritized transportation option depicted in FIG. 2 and elsewhere address such situations and more.

As mentioned above, the priority management system 105 can intelligently determine when and to which requestor devices to provide a prioritized transportation option. FIG. 3 illustrates the priority management system 105 determining to provide or remove a prioritized transportation option for display at a requestor device in accordance with one or more embodiments. As shown in FIG. 3, the priority management system 105 can utilize a variety of inputs and decisions in determining to provide or remove for display a prioritized transportation option at acts 312a or 312b. As described more below, the priority management system 105 determines and compares ETAs of candidate provider devices to select a candidate provider device with a shortest ETA to a pickup location for prioritized pickup. In addition, the priority management system 105 intelligently determines whether to surface (or remove) a prioritized transportation option based on requestor profile data and a current offer metric for prioritized transport.

As shown in FIG. 3, the priority management system 105 can identify a pickup location 302 for the requestor device 116a. For example, as described above in relation to FIG. 2, the priority management system 105 can determine the pickup location 302 utilizing real-time GPS data for the requestor device 116a. In the same or other embodiments, the priority management system 105 can receive a pickup location for the requestor device 116a according to user input indicated via the requestor device 116a.

In addition to the pickup location 302, the priority management system 105 can determine ETAs 304a-304f at the pickup location 302 for candidate transportation vehicles associated with the candidate provider devices 303a-303f To determine the ETAs 304a-304f, the priority management system 105 can estimate respective durations of time for candidate transportation vehicles to travel a route between the pickup location 302 and a current location corresponding to the candidate provider devices 303a-303f. In this regard, the priority management system 105 can utilize traffic data, weather data, construction data, etc. to determine the ETAs 304a-304f For example, in one or more implementations, the priority management system 105 multiplies an average time per distance for particular routes to determine ETAs. In these or other embodiments, the average time per distance for a given route is based on historical transportation data accounting for traffic data, weather data, construction data, etc.

Further, the priority management system 105 can utilize data specific to the candidate provider devices 303a-303f and/or corresponding candidate transportation vehicles, such as velocity data, gyroscope data, accelerometer data, magnetometer data, video data, microphone data, light detection and ranging (LIDAR) sensor data, inertial measurement unit data, etc. to determine the ETAs 304a-304f. Additionally or alternatively, the priority management system 105 can utilize application programming interfaces that allow the priority management system 105 to transmit ETA requests and receive ETA data from one or more third-party servers (e.g., Google Maps®).

Based on the ETAs 304a-304f, the priority management system 105 can compare the ETAs 304a-304f for candidate transportation vehicles corresponding to candidate provider devices 303a-303f at act 308. In particular, as mentioned above, the priority management system 105 can consider ETAs associated with provider devices that are unassigned (e.g., in idle status denoted via clear or unshaded cars) and provider devices that are currently assigned (e.g., in in-transit-to-pickup status denoted via solid or shaded cars). Because the priority management system 105 can consider ETAs associated with such an expanded supply of candidate provider devices, the priority management system 105 can more flexibly prioritize transport or expedite pickup of the requestor 120a.

As shown in FIG. 3, the priority management system 105 can select from candidate provider devices 303a, 303d, and 303e for prioritized transport of a requestor. Candidate provider devices 303a, 303d, and 303e represent additional candidates that would otherwise be unavailable to standard transportation options because standard transportation options do not consider provider devices operating in an in-transit-to-pickup status that are currently assigned and traveling to pick up a requestor.

In comparing the respective ETAs 304a-304f of 1 minute, 2.5 minutes, 2.5 minutes, 2 minutes, 3 minutes, and 3.5 minutes, the priority management system 105 can determine at act 308 that the candidate provider device 303a corresponds to an earliest ETA compared to the other candidate provider devices 303b-303f under consideration. In addition, the priority management system 105 can determine at act 308 that a next earliest ETA is 2 minutes corresponding to the candidate provider device 303d. Both the candidate provider devices 303a, 303d are in in-transit-to-pickup status and are therefore only currently available for prioritized transport. Accordingly, the priority management system 105 can determine that an earliest ETA according to a standard transportation option is 2.5 minutes corresponding to the candidate provider devices 303b, 303c. Based on the comparison of the ETAs 304a-304f, for instance, the priority management system 105 can select the candidate provider device 303a to provide prioritized transport of the requestor 120a.

In one or more embodiments, prior to providing a prioritized transportation option at the requestor device 116a at act 312a, the priority management system 105 considers additional factors. As one example factor shown in FIG. 3, the priority management system 105 analyzes requestor profile data 306 to determine whether to surface a prioritized transportation option. The requestor profile data 306 may include or relate to, for example: a requestor rating, a conversion percentage, a cancellation percentage, a travel history, a search history, payment methods, business accounts, previously requested upgrades, types of utilized transportation service categories, typical commute times, percentage of prime-time impacted transportation requests, scheduled trips, social media data, e-mails, text messages, device cookies, and/or metadata.

In one or more implementations, analyzing the requestor profile data 306 may include using one or more heuristic approaches for comparing the requestor profile data 306 to configurable thresholds. For example, if one or more portions of the requestor profile data 306 satisfy the configurable thresholds according to a heuristic approach, the priority management system 105 may determine that the requestor 120a is indeed a candidate for prioritized transport. On the other hand, if one or more portions of the requestor profile data 306 fail to satisfy the configurable thresholds according to a heuristic approach, the priority management system 105 may determine that the requestor 120a is not currently a candidate for prioritized transport.

As an example of comparing profile data to such a threshold, the requestor profile data 306 may include how many instances within a predetermined time range in which the requestor 120a has upgraded from a classic transportation option to a high value model (HVM) option or luxury transportation option with shorter ETAs. If the number of instances meets or exceeds a threshold number of upgrades, the priority management system 105 may extrapolate a probability that the requestor 120a will utilize a prioritized transportation option. Therefore, the priority management system 105 may determine that the requestor 120a is a candidate for prioritized transport based on the number of upgrades.

Additionally or alternatively, analyzing the requestor profile data 306 may include the priority management system 105 implementing a machine-learning model to predict whether the requestor 120a will select a prioritized transportation option if presented. Such a machine-learning model can include a support vector machine, a convolutional neural network, a decision tree, among other types of machine-learning models. In these or other embodiments implementing a machine-learning model, the priority management system 105 utilizes one or more factors as inputs for the machine-learning model, such as a requestor rating, a conversion percentage, a cancellation percentage, a travel history, a search history, payment methods, business accounts, previously requested upgrades, types of utilized transportation service categories, typical commute times, percentage of prime-time impacted transportation requests, scheduled trips, social media data, e-mails, text messages, device cookies, and/or metadata.

If the machine-learning model predicts a conversion probability for the requestor 120a that is within a threshold range of conversion probabilities, the priority management system 105 may determine that the requestor 120a is indeed a candidate for prioritized transport. On the other hand, if the machine-learning model predicts a conversion probability for the requestor 120a that is not within a threshold range of conversion probabilities, the priority management system 105 may determine that the requestor 120a is not a candidate for prioritized transport.

In these or other embodiments, the priority management system 105 can train a machine-learning model to generate a predicted conversion probability in response to requestor device activity (e.g., based on ground truth data, such as actual/observed instances of conversion in the requestor profile data 306). For example, the priority management system 105 can utilize a neural network to analyze training data comprising historical travel activity. In turn, the neural network can generate predicted conversion probabilities for the training data. Based on a comparison between the predicted conversion probabilities and the ground truth conversions (e.g., by applying a loss function), the priority management system 105 can learn to predict conversion probabilities by backpropagating a measure of loss reflecting differences between the predicted conversion probabilities and the ground truth data.

In addition to ETAs of candidate provider devices and the requestor profile data 306, the priority management system 105 can also account for a current offer metric for prioritized transport as a factor in determining whether to provide a prioritized transportation option to the requestor device 116a. The current offer metric for prioritized transport can help the priority management system 105 identify whether more or fewer prioritized transportation options should be presented or removed for display at requestor devices at a given time and/or geographic area (e.g., to control ETA degradation and other unpleasant experiences for providers and non-prioritized requestors).

As shown in FIG. 3, the priority management system 105 at act 310 can determine a current offer metric for prioritized transport in relation to a prioritized-transportation limit for prioritized transportation options. The current offer metric for prioritized transport reflects a current number of outstanding prioritized transportation options (e.g., executed+unexecuted prioritized transportation options). The prioritized-transportation limit reflects a total number of allowed outstanding prioritized transportation options that the priority management system 105 can present to requestor devices and/or execute at a given time (or duration of time). Thus, when the current offer metric reaches the prioritized-transportation limit for prioritized transportation options, the priority management system 105 will temporarily discontinue providing prioritized transportation options (e.g., until one or more prioritized transports are completed).

Additionally or alternatively, as the current offer metric approaches the prioritized-transportation limit for prioritized transportation options, the priority management system 105 can subsequently allow fewer additional requestor devices to qualify for prioritized transport. Moreover, in some embodiments, as the current offer metric approaches, meets, or exceeds the prioritized-transportation limit for prioritized transportation options, the priority management system 105 can remove an unexecuted prioritized transportation option for display at a requestor device. For instance, prior to a requestor device selecting and/or confirming a prioritized transportation option presented to the requestor device, the priority management system 105 can remove the prioritized transportation option for display at the requestor device. In removing an ephemeral prioritized transportation option for display at a requestor device, the priority management system 105 can reduce the current offer metric.

In some embodiments, the priority management system 105 can change the prioritized-transportation limit for prioritized transportation options based on inflow of provider devices (and vehicles) and requests from requestors within a geographic area. For example, to reduce system inefficiencies and/or mitigate a reduction in transportation throughput, the priority management system 105 can dynamically increase or decrease the prioritized-transportation limit for prioritized transportation options such that demand for prioritized transport and demand for standard transport together are less than or equal to a supply of provider devices in idle status.

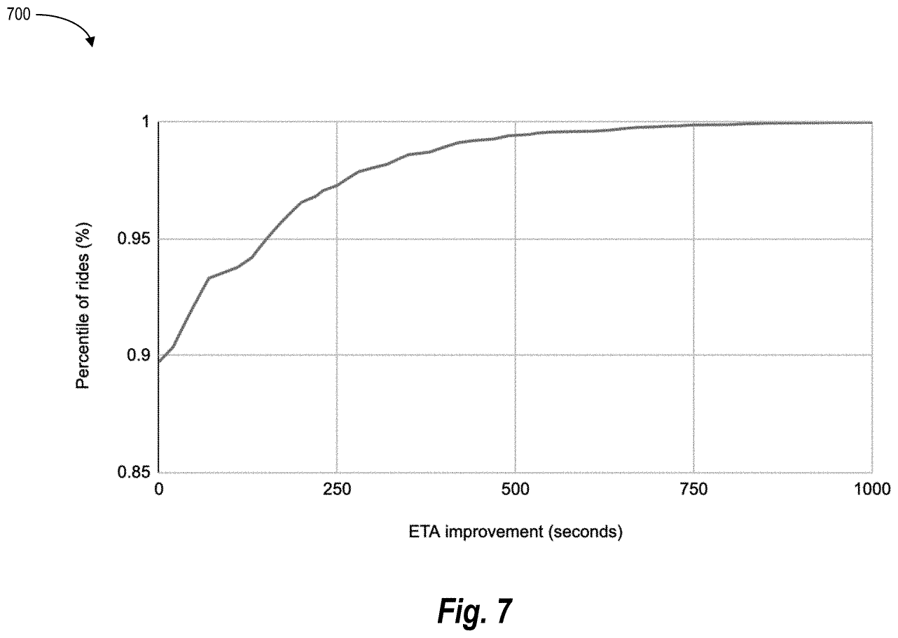

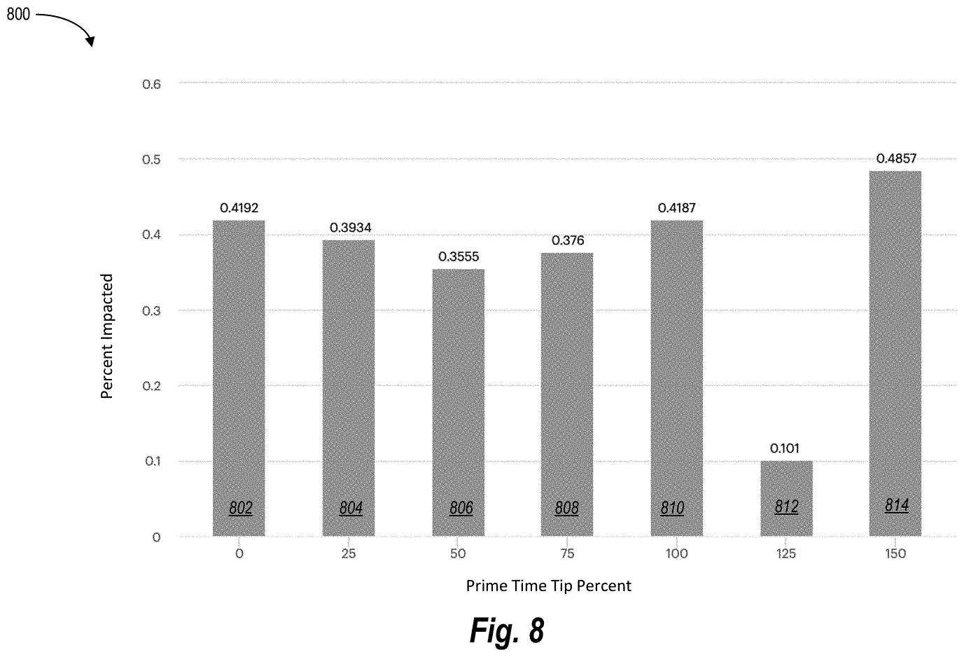

In some embodiments, the priority management system 105 controls the prioritized-transportation limit such that a specific threshold (e.g., less than 1%) of transportation requests correspond to prioritized transportation requests. By controlling the prioritized-transportation limit, the priority management system 105 can ensure that demand for prioritized transport does not become excessive (e.g., during busy times) and thereby degrade system efficiencies and/or disrupt other pricing mechanisms. Testing results described more below in relation to FIGS. 7-8 indicate how well the priority management system 105 balances the prioritized-transportation limit to improve ETA for prioritized transport and increase a profit metric without degrading system efficiencies and disrupting other pricing mechanisms.

As just alluded to, the priority management system 105 can dynamically respond to provider device inflow and requests from requestors by also utilizing an adaptive pricing mechanism associated with prioritized transportation options. For example, as requestor demand increases (e.g., during commute hours or rainy weather), the priority management system 105 can adaptively apply a higher premium cost on top of other bases costs or premiums associated with standard transport. In this regard, the priority management system 105 can apply multiple pricing mechanisms to determine a requestor's cost for prioritized transport.

For instance, the priority management system 105 can apply, for prioritized transportation options, an additional premium on top of a base premium paid by requestors for standard transport. On the one hand, if no requestor wants prioritized transport, the priority management system 105 sets the additional premium to 0, and the base premium remains the same. On the other hand, for example, if 100% of the requestors want prioritized transport, the priority management system 105 can apply a large premium to reduce the requestor demand for prioritized transport to a predetermined threshold (e.g., to <1% to avoid ETA degradation or disruption of other pricing mechanisms). Of course, the remaining requestors that do not convert on that large premium (e.g., the base premium plus the additional premium) get normal service levels according to standard transport at the base premium service level.

Additionally or alternatively, the priority management system 105 can determine a requestor's cost for prioritized transport based on a profit metric. In an example embodiment, the priority management system 105 can determine a profit metric according to the following function:

Profit=(#requestors offered FastPass)*(% conversion on FastPass)*(FastPass $ premium−loss from requestor we took from−compensation to original provider if we swap after matching),

where the term “#requestors offered FastPass” represents the number of outstanding prioritized transportation options, and the term “% conversion on FastPass” represents a percentage of the outstanding prioritized transportation options that converted to a completed transportation as a result of requestor selection and confirmation. In addition, the term “FastPass $ premium” represents the requestor's costs for prioritized transport, the term “loss from requestor we took from” represents an averaged expected loss due to cancellation of requestors whom had their selected provider switched to a prioritized requestor, and the term “compensation to original provider if we swap after matching” represents an average compensation value or expected cost for compensating a provider who is swapped out for a closer provider after making progress towards the requestor for prioritized transport. Thus, for a desired (e.g., minimum) profit metric, the priority management system 105 can solve for the “FastPass $ premium” term to determine a requestor's cost for prioritized transport.

In more detail with respect to certain terms of the profit metric, in some embodiments, the priority management system 105 can determine the term “loss from requestor we took from” by multiplying a predetermined amount of an average fare by a percentage of requestor cancellations that occur after a provider cancels on them. Additionally, in some embodiments, the priority management system 105 accounts for a potential long-term retention loss or impact as a result of a prioritized transport provided to one requestor over another. Further, in some cases, the priority management system 105 equates the term “compensation to original provider if we swap after matching” to the following expression:

$$\% of requestors swapped postmatching * [ ( minute ratecard * avg travel time of original provider before swap ) + ( mile ratecard * avg transportation vehicle speed * ( \frac{avg travel time of original provider before swap}{60} ) ) ] ,$$

where the term “% of requestors swapped postmatching” represents an average percentage of transportation assignments that the priority management system 105 reassigns to a different provider after an initially assigned provider, the term “minute ratecard” represents a provider-earnings-per-minute metric for a geographic area, and the term “mile ratecard” represents a provider-earnings-per-mile metric for the geographic area. In addition, the term “avg travel time of original provider before swap” represents an average amount of travel time that, if a provider is swapped out, the provider will have typically traveled this amount of time. Further, the term “avg transportation vehicle speed” represents an average velocity (e.g., in miles per hour) of a transportation vehicle associated with a provider.

Based on one or more of the foregoing acts and algorithms, the priority management system 105 can determine to provide (or remove) a prioritized transportation option for display at the requestor device 116a. For example, in one or more implementations, the priority management system 105 compares the determined profit metric to a threshold profit metric. If the determined profit metric satisfies (e.g., meet or exceed) the threshold profit metric, then the priority management system 105 can determine to provide the prioritized transportation option. Otherwise, if the determined profit metric fails to satisfy the threshold profit metric, then the priority management system 105 can determine not to provide the prioritized transportation option.

Additionally or alternatively, in some embodiments, the priority management system 105 implements a desired profit metric and solves for the requestor's cost for prioritized transport (e.g., the “FastPass $ premium”). If the requestor's costs for prioritized transport is within a threshold cost range, then the priority management system 105 can determine to provide the prioritized transportation option. Otherwise, if the requestor's costs for prioritized transport is not within the threshold cost range, then the priority management system 105 can determine not to provide the prioritized transportation option.

Based on the determination to provide the prioritized transportation option, at act 312a, the priority management system 105 can provide, for display at the requestor device 116a, a user interface 316 comprising a prioritized transportation option 318. As shown in FIG. 3, the prioritized transportation option 318 comprises a selectable toggle 320, an ETA differential 322, and a price differential 324. The prioritized transportation option 318 is described in greater detail below in relation to FIGS. 6A-6D.

As suggested by FIG. 3, however, the prioritized transportation option 318 indicates the priority management system 105 ghost-matched a specific provider device (e.g., the candidate provider device 303a) for prioritized transport of the requestor device 116a. Based on this specific ghost-match, the priority management system 105 can surface the prioritized transportation option 318 with a particular ETA differential. For example, the priority management system 105 provides data for the ETA differential 322, which indicates an estimated improvement time in terms of ETA over standard transportation options. In addition, the priority management system 105 can surface the price differential 324 of $4.00 to indicate a premium or added cost for prioritized transport according to the prioritized transportation option 318. Indeed, in some embodiments, a price for the prioritized transportation option 318 reflects an actual cost for a prioritized transportation. In some cases, the priority management system 105 determines a cost for the prioritized transportation option 318 to include a cost of removing provider device operating in an in-transit-to-pickup status (and traveling to an assigned pickup location) from a previous transportation assignment in terms of cost to both the provider and requestor.

When a requestor accepts the prioritized transportation option 318 as indicated in the user interface 316, the requestor device 116a detects a user interaction (e.g., a tap, swipe, click) with the selectable toggle 320. Based on detecting the user interaction, the requestor device 116a provides an indication of the user selection to the priority management system 105. In response, the priority management system 105 can update the user interface 316 as described below in relation to FIG. 6B.

As further shown in FIG. 3, in one or more embodiments, the priority management system 105 performs an act 314 to iterate one or more acts and algorithms described above. In some embodiments, the priority management system 105 at act 314 iterates to search for better candidate provider devices with an earlier ETA than the ETA 304a. In some cases, the priority management system 105 continuously (or at predetermined intervals) iterates one or more of the foregoing acts up until the assigned provider device (e.g., the candidate provider device 303a) is within a threshold time and/or a threshold distance to the pickup location for the requestor device (e.g., the pickup location 302). For instance, the priority management system 105 no longer searches for a different candidate provider device when the assigned candidate provider device has an ETA to the pickup location of less than about 120 seconds or is within a threshold distance (e.g., a haversine distance) to the pickup location of less than about 400 meters.

For example, the priority management system 105 may compare updated ETAs at act 308. The updated ETAs may include additional or alternative candidate provider devices not initially considered. To illustrate, in response to an iteration of determining candidate provider devices and comparing associated ETAs as described above, the priority management system 105 may determine that a candidate transportation vehicle associated with candidate provider device 303g has an ETA of thirty seconds at the pickup location 302 for the requestor device 116a. The candidate provider device 303g may correspond to a provider device having just come online for receiving a transportation assignment. Alternatively, the candidate provider device 303g may correspond to a provider device having just finished a transportation assignment and has therefore switched from the active-transport status to idle status.

In either case, in some embodiments, the priority management system 105 determines that the candidate provider device 303g is associated with an earlier ETA at the pickup location 302 compared to the candidate provider device 303a. In response, the priority management system 105 can update the user interface 316 (e.g., the ETA differential 322) to reflect the ETA improvement due to the newly selected candidate provider device 303g. In some cases, the priority management system 105 may have already executed the prioritized transportation option by assigning a prioritized transportation request to the candidate provider device 303a. In this event, the priority management system 105 may reassign the prioritized transportation request to the candidate provider device 303g (e.g., as shown and described in relation to FIG. 6D) as a result of iteratively looking for a candidate provider device associated with an earlier ETA at the pickup location 302.

As suggested above, the priority management system 105 can prioritize assigning a provider device to a prioritized requestor over a standard requestor. For instance, in some embodiments, the priority management system 105 assigns the candidate provider device 303g to the requestor device 116a over the requestor device 116n that, for instance, is associated with a standard transportation request. Notwithstanding the candidate provider device 303g corresponds to an earlier ETA for the requestor device 116n, the priority management system 105 can assign the candidate provider device 303g to pick up the requestor device 116a according to an updated prioritized transportation option.

Additionally or alternatively, in some cases, the priority management system 105 may receive a standard transportation request from the requestor device 116n prior to receiving confirmation of the updated prioritized transportation option from the requestor device 116a. In these or other embodiments, the priority management system 105 can still assign the candidate provider device 303g to pick up the requestor device 116a, and not the requestor device 116n, according to the updated prioritized transportation option.

In some embodiments, the priority management system 105 utilizes a reservation or timed-offer approach for prioritized transportation options. Although the user interface 316 does not illustrate a timer or countdown element, in one or more implementations, in certain implementations, the priority management system 105 provides such a time-based element that indicates a remaining time window during which a prioritized transportation option will remain valid or reserved for selection. At expiration of the time window (e.g., twenty seconds, thirty seconds, sixty seconds), the priority management system 105 can perform act 312b to remove the prioritized transportation option for display from the requestor device 116a. That is, past the expiration of the time window, the priority management system 105 cannot or does not reserve or otherwise guarantee that one or more particular providers will be available to fulfill a prioritized transportation option.

Based on expiration of the timed offer for the prioritized transportation option, the priority management system 105 may perform the act 314 to iterate one or more of the foregoing acts or algorithms. Based on the considerations described above, the priority management system 105 may, select a same or different candidate provider device to provide prioritized transport for the requestor device 116a and provide for display a new prioritized transportation option for a different provider device at act 312a. Because the priority management system 105 can switch a selected candidate provider device after initially providing the prioritized transportation option, in some embodiments, the priority management system 105 does not reserve or promise a specific candidate provider device. Alternatively, the priority management system 105 may determine not to provide another prioritized transportation option for display at the requestor device 116a.

In additional or alternative embodiments, the priority management system 105 at act 308 (whether for a first run or a subsequent iteration run) may determine that the ETAs for the candidate transportation vehicles respectively associated with the provider devices 303a-303g do not satisfy a threshold arrival-time difference to warrant surfacing a prioritized transportation option to a requestor device. For example, in situations where the priority management system 105 determines that requestor demand is low and/or provider supply (e.g., in idle status) is high, a difference in ETAs associated with provider devices in idle status may be comparable or even better (e.g., within a threshold range) to those of provider devices in in-transit-to-pickup status. Therefore, the priority management system 105 may determine not to provide a prioritized transportation option or else remove a prioritized transportation option for display at act 312b.

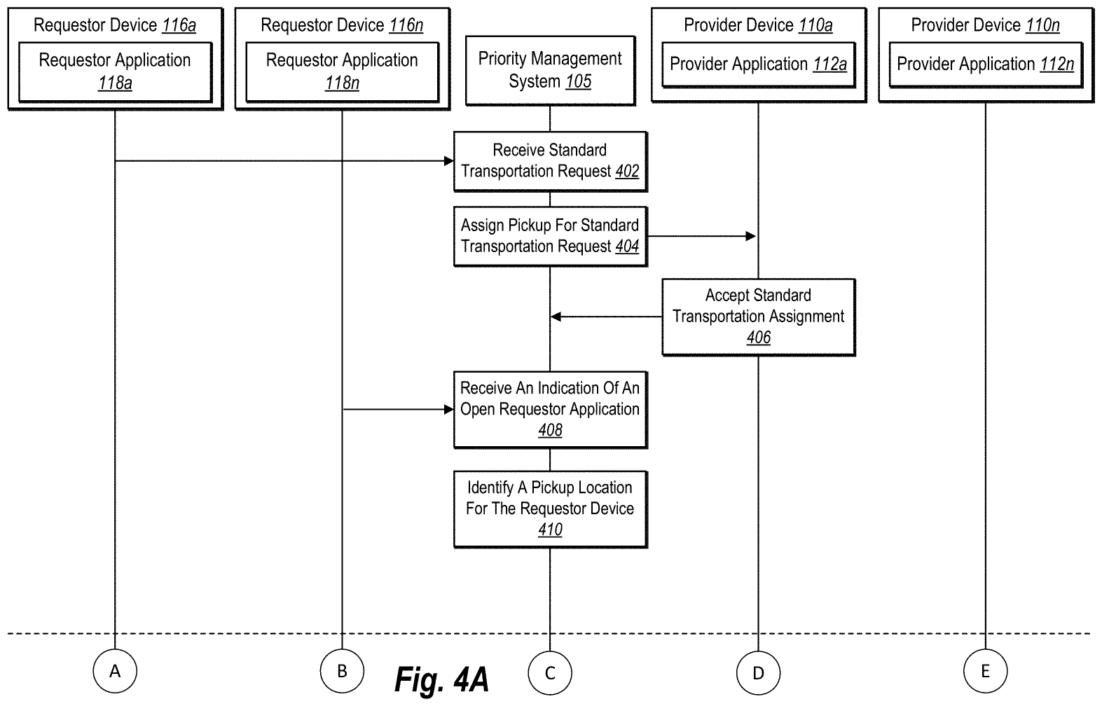

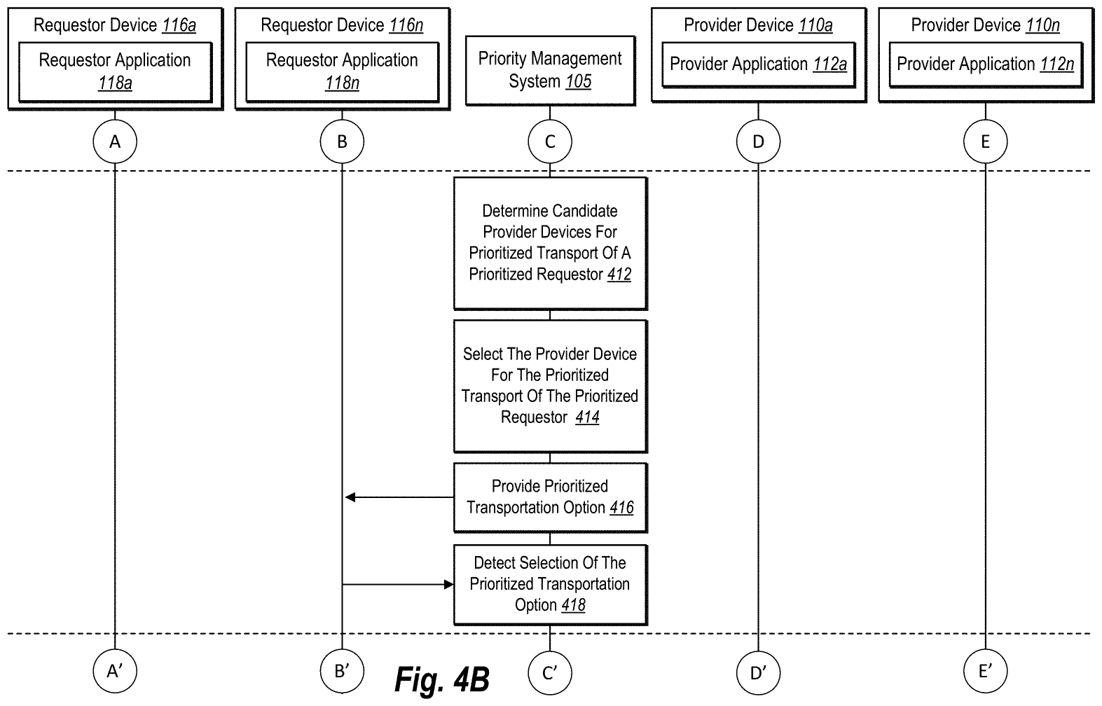

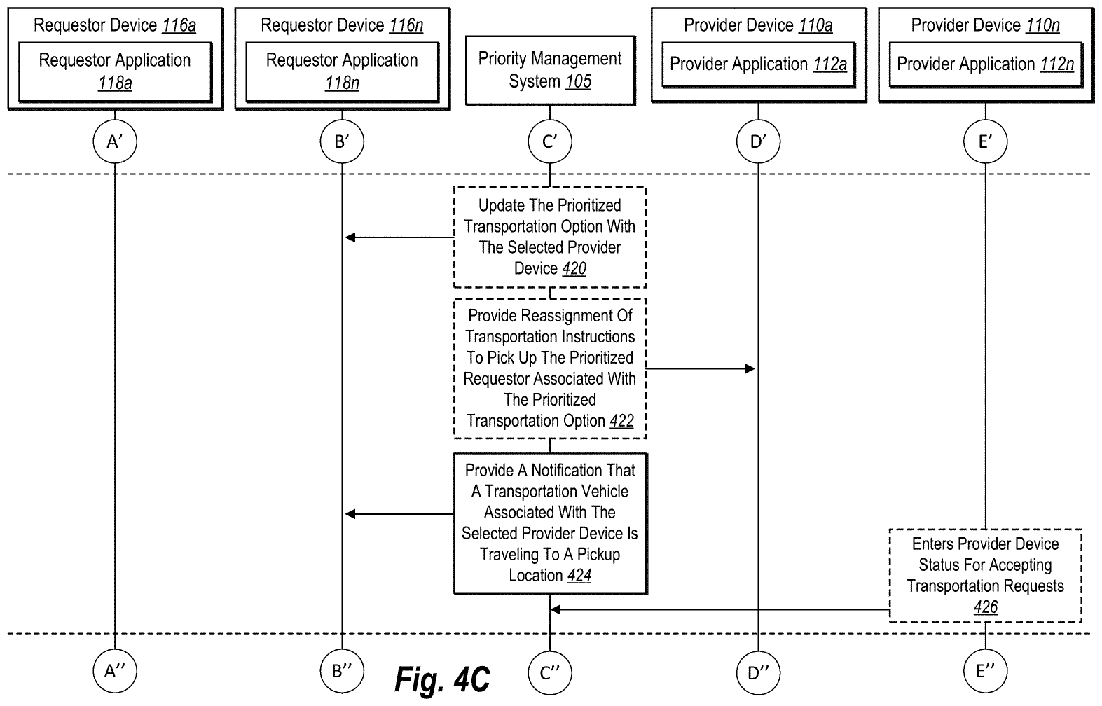

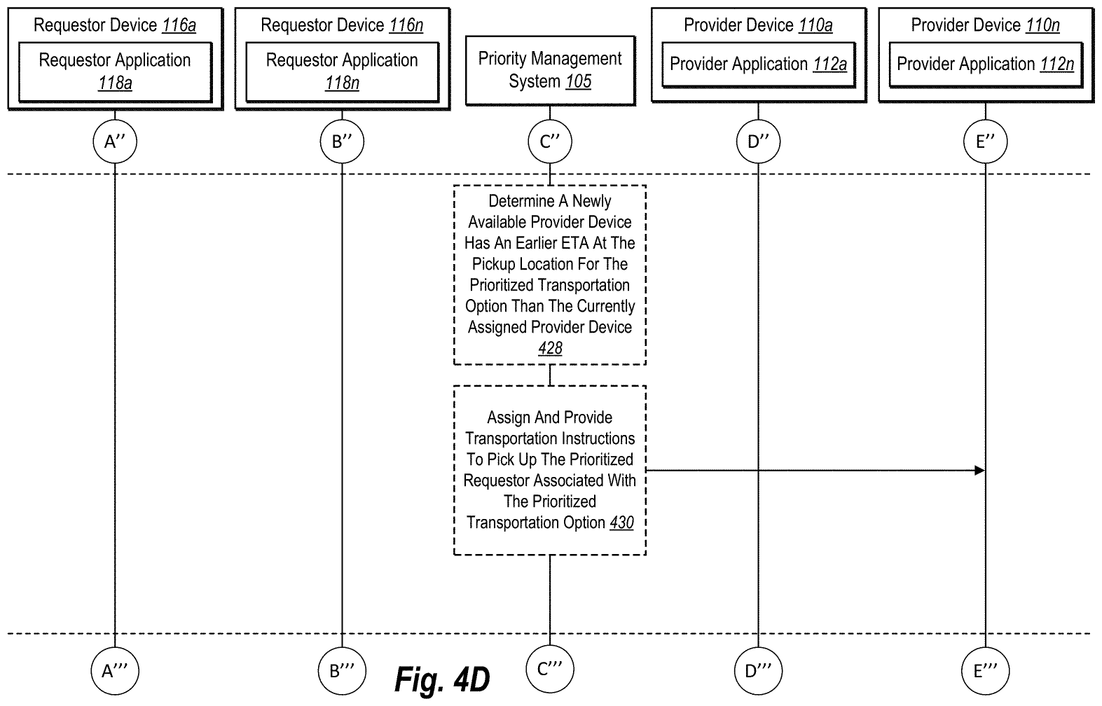

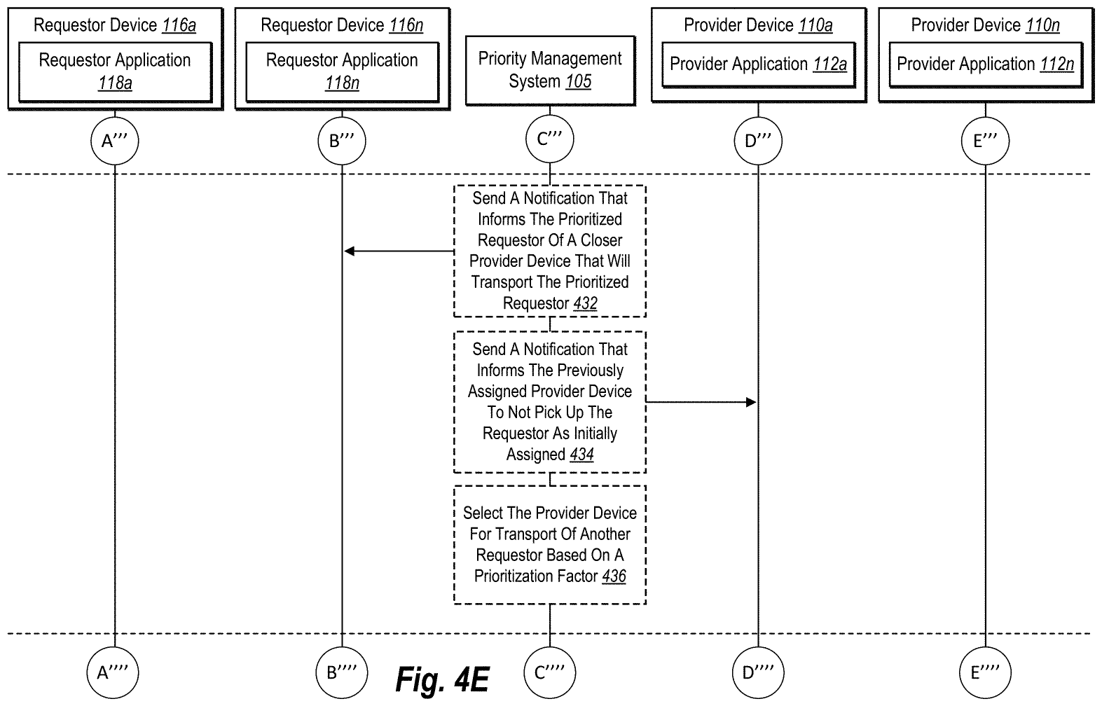

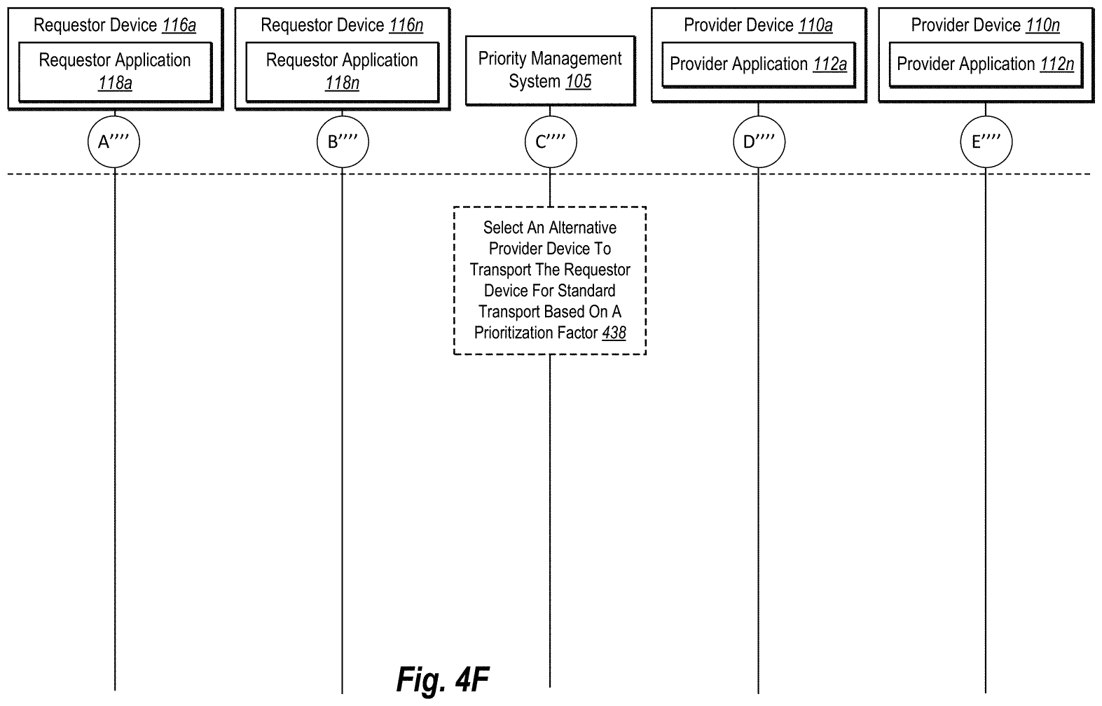

As mentioned above, the priority management system 105 can select (i) a provider device in idle status unassigned to a requestor or (ii) a provider device in in-transit-to-pickup status assigned to an initial requestor to pick up a prioritized requestor. In accordance with one or more embodiments, FIGS. 4A-4F illustrate a sequence diagram of the priority management system 105 selecting a provider device in various states from among candidate provider devices for prioritized transport of a requestor and providing a prioritized transportation option to a requestor device for prioritized transport of the requestor by the selected provider device.

As described more below, in FIGS. 4A-4F, the priority management system 105 can receive a standard transportation request from a requestor device and assign a corresponding transportation assignment to a provider device. In response to identifying a prioritized requestor eligible for prioritized transport, the priority management system 105 can reassign the provider device to the prioritized requestor. In some embodiments, the priority management system 105 also identifies a newly available provider device with an earlier ETA than the reassigned provider device. In this case, the priority management system 105 can assign pickup for the prioritized requestor to the newly available provider device with an earlier ETA. In addition, the priority management system 105 can select an alternative requestor for the previously assigned provider device and an alternative provider for the previously assigned requestor for standard transport.

As shown in FIG. 4A, the priority management system 105 receives a standard transportation request from the requestor device 116a at act 402. The standard transportation request may include a request for standard transport, shared transport, etc. without a corresponding premium for a prioritized transport. In response to receiving the standard transportation request from the requestor device 116a, the priority management system 105 assigns pickup for the standard transportation request to the provider device 110a at act 404. The transportation assignment may include a pickup location for the requestor device 116a. In addition, the transportation assignment may include navigational instructions for directing the provider device 110a to the pickup location for the requestor device 116a.

At act 406, the provider device 110a accepts the transportation assignment according to the standard transportation request associated with the requestor device 116a. In these or other embodiments, the priority management system 105 can update the navigational instructions on the provider application 112a as the provider device 110a navigates towards the pickup location (e.g., as the priority management system 105 detects real-time (or near real-time) changes in GPS data for the provider device 110a). Additionally or alternatively, the priority management system 105 can update the provider device 110a (via the requestor application 118a) to reflect real-time (or near real-time) changes in position and/or ETA of the transportation vehicle 108a associated with the provider device 110a at the pickup location. Thus, the priority management system 105 can dynamically track progress of the provider device 110a towards the requestor for standard transport.

At act 408, the priority management system 105 receives an indication of the requestor device 116n opening the requestor application 118n. Additionally or alternatively, the priority management system 105 may receive an indication of the requestor device 116n providing user input via the requestor application 118n (e.g., of a destination location).

In response to the priority management system 105 receiving an indication of the requestor device 116n opening the requestor application 118n and/or providing one or more user inputs, the priority management system 105 identifies a pickup location for the requestor device 116n at act 410. As described above in relation to the foregoing figures, identifying a pickup location for the requestor device 116n may include the priority management system 105 utilizing real-time GPS data to identify a current location of the requestor device 116n. Based on the current location, the priority management system 105 may determine that the current location or a nearby location (e.g., at a sidewalk curb, airport terminal pickup area) is the pickup location for the requestor device 116n.

At act 412 shown in FIG. 4B, the priority management system 105 determines candidate provider devices for prioritized transport of a prioritized requestor (e.g., the requestor 120n associated with the requestor device 116n). As described above in relation to the foregoing figures, the priority management system 105 can determine provider devices are candidate provider devices if in idle status, in-transit-to-pickup status, or in active-transport status and are positioned within a threshold ETA, a threshold distance, or a particular geographic area (e.g., within city limits, a specific geocoded region or geocoded area). Additionally or alternatively to act 412 or other act(s), the priority management system 105 can also determine whether the requestor device 116n is a candidate for prioritized transport (e.g., based on requestor profile data or a current offer metric as described above in relation to FIG. 3).

At act 414, the priority management system 105 selects a provider device (e.g., the provider device 110a) for the prioritized transport of the prioritized requestor (e.g., the requestor 120n associated with the requestor device 116n). For example, as described above, the priority management system 105 can compare ETAs associated with the candidate provider devices and select the provider device associated with an earliest ETA at the pickup location of the requestor device 116n.

By ghost-matching the provider device 110a and the requestor device 116n at act 414, the priority management system 105 provides a prioritized transportation option at act 416 with a specific and accurate ETA improvement compared to standard transportation options. In some cases, the priority management system 105 may subsequently switch the provider device 110a with another candidate provider device. However, ghost-matching the provider device 110a and the requestor device 116n allows the priority management system 105 to show specific availability of the provider device 110a (albeit not guaranteed) in the prioritized transportation option. Indeed, as described in the present disclosure, the priority management system 105 can, in one or more implementations, provide a prioritized transportation option with an ETA differential, a price differential, a provider indicator for the provider device 110a, and/or a graphical representation of a mapped route of the provider device 110a relative to the pickup location of the requestor device 116n.

At act 418 in FIG. 4B, the priority management system 105 detects selection of the prioritized transportation option. For example, in response to user input at a selectable toggle of the prioritized transportation option, the priority management system 105 may receive an indication that the requestor device 116n has opted to receive prioritized transport. Additionally or alternatively, the act 418 may include the priority management system 105 detecting a second selection comprising a confirmation input at the requestor application 118n that confirms selection of the prioritized transportation option.

Based on the detected selection of the prioritized transportation option at act 418, in some embodiments, the priority management system 105 at act 420 in FIG. 4C updates the prioritized transportation option to include additional detail regarding the prioritized transportation option. For example, responsive to a user input at a selectable toggle of the prioritized transportation option, the priority management system 105 may instantly update the prioritized transportation option for display within the requestor application 118n. In some embodiments, the priority management system 105 may update the prioritized transportation option to show which specific provider device (e.g., the provider device 110a) the priority management system 105 has ghost-matched to the requestor device 116n to provide prioritized transport. Additionally or alternatively, the priority management system 105 may update the prioritized transportation option to show a real-time position of the provider device 110a. Further, the priority management system 105 may update the prioritized transportation option to show a potential route of the provider device 110a to the requestor device 116n for prioritized pickup should the requestor device 116n confirm the prioritized transportation option.

At act 422 in FIG. 4C, the priority management system 105 optionally provides reassignment of transportation instructions to a provider device (e.g., the provider device 110a) to pick up the prioritized requestor associated with the prioritized transportation option. For example, the priority management system 105 can update the provider device 110a (via the provider application 112a) currently displaying the initial transportation assignment and navigational instructions corresponding to pickup of the requestor associated with the requestor device 116a. That is, the priority management system 105 can update the provider device 110a (via the provider application 112a) to instead display a transportation assignment and associated navigational instructions to pick up the requestor associated with requestor device 116n for prioritized transport. Because the provider device 110a is already in in-transit-to-pickup status, the priority management system 105 can instantly reassign the provider device 110a (e.g., without needing acceptance from the provider device 110a) to pick up the requestor associated with requestor device 116n for prioritized transport. Additionally, as mentioned above, the priority management system 105 can determine a compensation value (or expected value) to compensate the provider associated with the provider device 110a for any increase in travel time or in-transit-to-pickup status as a result of the reassignment.

At act 424 in FIG. 4C, the priority management system 105 provides a notification to the requestor device 116n that a transportation vehicle associated with selected provider device (e.g., the provider device 110a) is traveling to a pickup location (e.g., a message the vehicle is “on the way”). For example, as shown in FIG. 6C and as described below, the priority management system 105 can update the requestor application 118n to reflect a real-time (or near real-time) position and/or ETA of the provider device 110a as the provider device 110a proceeds to the pickup location of requestor device 116n. Additionally or alternatively, the priority management system 105 may indicate (e.g., via notification) to the requestor device 116n that the provider 110a is not guaranteed and may be substituted with a different provider device.

At act 426, in one or more embodiments, the priority management system 105 receives an indication that the provider device 110n enters a status (e.g., switched to idle status) for accepting transportation requests. As described above, the provider device 110n may correspond to a provider device having just come online for receiving a transportation assignment. Alternatively, the provider device 110n may correspond to a provider device having just finished a transportation assignment and has therefore switched from active-transport status to idle status.

As shown at act 428 in FIG. 4D, in one or more embodiments, the priority management system 105 determines that a newly available provider device (e.g., the provider device 110n) has an earlier ETA at the pickup location for the prioritized transportation option than the currently assigned provider device (e.g., the provider device 110a). For example, in response to iteratively determining candidate provider devices and comparing ETAs as described above in relation to FIG. 3, the priority management system 105 can determine than the provider device 110n corresponds to an earliest ETA at the pickup location.

In response to determining a newly available provider device corresponds to an earlier ETA than the currently assigned provider device, in some embodiments, the priority management system 105 at act 430 assigns and provides transportation instructions to the newly available provider device for picking up the prioritized requestor associated with the prioritized transportation option. For instance, the priority management system 105 may provide a transportation assignment to the provider device 110n that includes a pickup location for the requestor device 116n. In addition, the transportation assignment may include navigational instructions for directing the provider device 110n to the pickup location from a current location of the requestor device 116n.

At act 432 in FIG. 4E, in one or more embodiments, the priority management system 105 sends a notification to the prioritized requestor device (e.g., the requestor device 116n) that informs the prioritized requestor of a closer provider device (e.g., the provider device 110n) that will transport the prioritized requestor. For example, as shown in FIG. 6D and as described below, the priority management system 105 can update the requestor device 116n (via the requestor application 118n) to reflect the provider substitution, including a corresponding provider information (e.g., name, make/model of an associated transportation vehicle). Additionally or alternatively, the priority management system 105 can update the requestor device 116n (via the requestor application 118n) to reflect real-time (or near real-time) changes in position and/or ETA of the transportation vehicle associated with the provider device 110n at the pickup location.

In response to determining the provider device 110n corresponds to an earlier ETA than the provider device 110a, the priority management system 105 at act 434 optionally sends a notification that informs the previously assigned provider device (e.g., provider device 110a) to not pick up the prioritized requestor (e.g., requestor associated with the requestor device 116n) as initially assigned. In these or other embodiments, the priority management system 105 updates the provider device 110a (via the provider application 112a) to indicate that the priority management system 105 found a closer provider for picking up the requestor associated with the requestor device 116n for prioritized transport. In addition, the priority management system 105 can update the provider application 112a to reflect a compensation amount for time and distance traveled (e.g., based on a rate for a provider device in-transit-to-pickup status or a rate for a provider device in active-transport status) in accordance with the transportation assignment for prioritized transport. Moreover, in one or more implementations, the priority management system 105 updates the provider application 112a to indicate the provider device 110a is being prioritized for matching with another requestor (e.g., to minimize time in idle status).

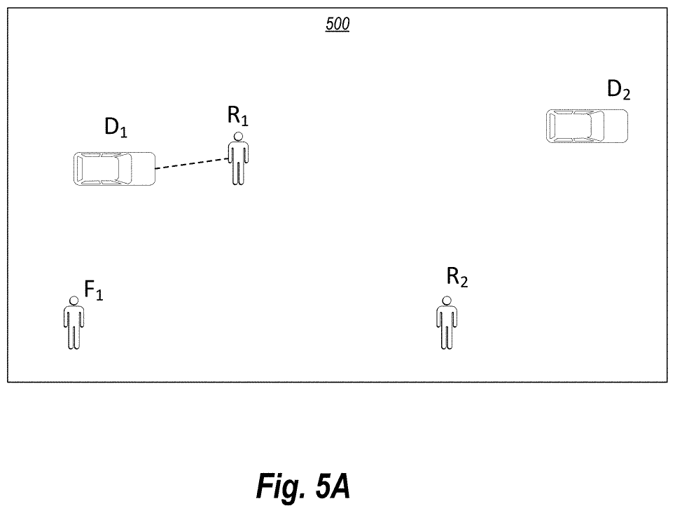

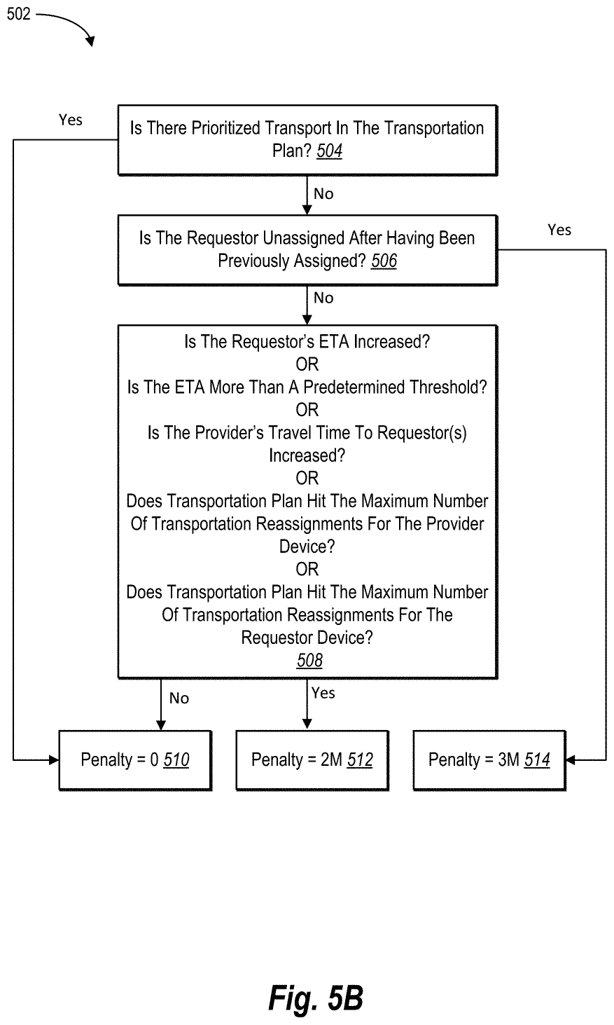

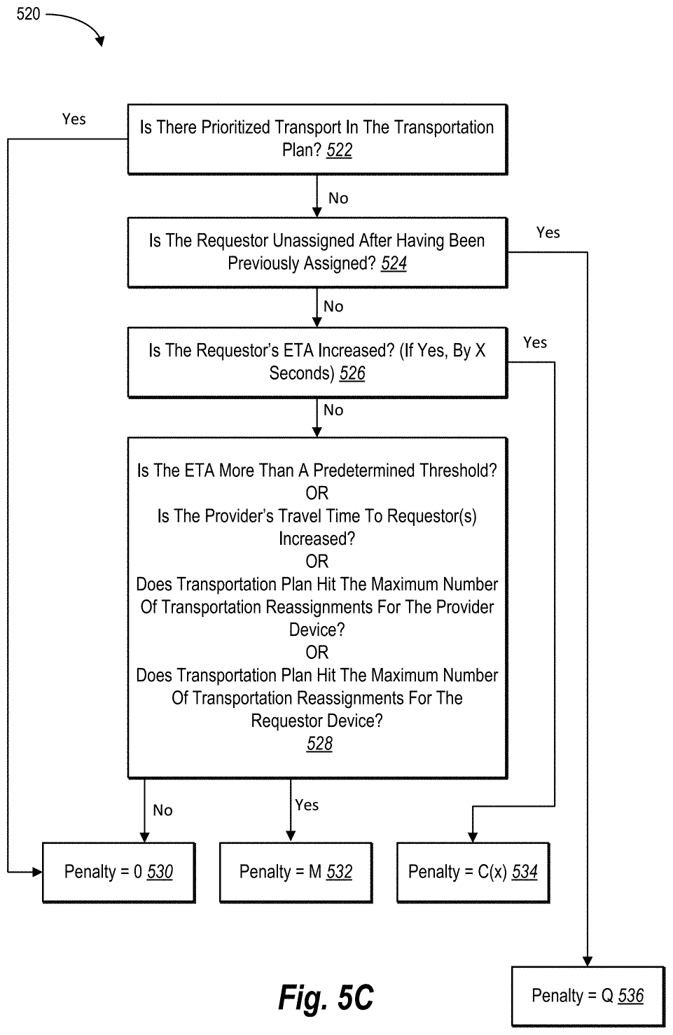

At act 436 in FIG. 4E, in one or more embodiments, the priority management system 105 selects the previously assigned provider device (e.g., the provider device 110a) for transport of another requestor based on a prioritization factor. Prioritization factors are discussed more below in relation to FIGS. 5A-5C. In general, however, the priority management system 105 can apply a prioritization factor to a matching score of the provider device 110a such that the priority management system 105 more quickly matches the provider device 110a to a requestor device.

Similarly, at act 438 in FIG. 4F, in one or more embodiments, the priority management system 105 selects an alternative provider device to transport the standard requestor (e.g., the requestor associated with the requestor device 116a) for standard transport based on a prioritization factor. For example, as a result of the priority management system 105 effectively bumping the requestor device 116a by reassigning the provider device 110a to the requestor device 116n for prioritized transport, the priority management system 105 can subsequently prioritize the requestor device 116a. In some cases, the priority management system 105 expedites a matching process and/or weight a selection of a candidate provider device with an earlier ETA for an expedited pickup of the requestor device 116a.

While FIGS. 4A-4F illustrate acts according to one embodiment, alternative embodiments may omit, add to, reorder, and/or modify any of the acts shown in FIGS. 4A-4F. For example, in one or more implementations, the priority management system 105 can perform another search for candidate provider devices and compare ETAs after detecting selection of the prioritized transportation option at act 418 and prior to executing a swap as reflected in act 422. In this manner, the priority management system 105 can ensure that the priority management system 105 is providing a best match for the prioritized requestor. Additionally or alternatively, the priority management system 105 may generate matching scores based on prioritization factors as described below in FIGS. 5A-5C in connection with one or more of the acts just described (e.g., act 414).

As mentioned above, the priority management system 105 can select one of the candidate provider devices for prioritized transport of the requestor based on matching scores associated with potential transportation plans. In accordance with one or more embodiments, FIG. 5A illustrates a schematic configuration 500 of transportation vehicles and requestors for which the priority management system 105 generates transportation plans. Specifically, the schematic configuration of transportation vehicles and requestors in FIG. 5A shows an example scenario involving an unassigned prioritized requestor, an unassigned standard requestor, a requestor assigned to a particular provider, and an unassigned provider. According to this example scenario, the priority management system 105 generates a set of potential transportation plans for scoring. Based on the potential transportation plans corresponding to the schematic configuration 500 of FIG. 5A, FIGS. 5B-5C illustrate respective process flows for generating matching scores for the potential transportation plans in accordance with one or more embodiments.

As shown in the example configuration of FIG. 5A, the transportation vehicle D1 is en route to pick up a requestor R1 according to a transportation assignment assigned to a provider device associated with a transportation vehicle D1. In this case, the provider device associated with the transportation vehicle D1 is in in-transit-to-pickup status. In addition, a provider device associated with a transportation vehicle D2 is in idle status awaiting a transportation assignment. Further, a requestor R2 has submitted a transportation request for standard transport and is awaiting a matched provider. Additionally, a prioritized requestor F1 has submitted a transportation request for prioritized transport according to a prioritized transportation option.

According to this example configuration of FIG. 5A, the priority management system 105 can generate potential transportation plans as indicated in the following Table 1. With each transportation plan, the priority management system 105 can generate a preliminary matching score (e.g., before assessing a prioritization factor to penalize or boost the preliminary matching score). In one or more embodiments (and for ease of discussion), the priority management system 105 may generate a preliminary matching score for each transportation plan as equivalent to 1 over an ETA for a vehicle corresponding to the transportation plan (e.g., ⅓).

TABLE 1

| | | Preliminary |
|---|---|---|
| Transportation | ETA | Matching |
| Plan | (min) | Score |
| D1-R1 | 3 | 1/3 |
| D2-R1 | 7 | 1/7 |
| R1 | N/A | 0 |
| D1-R2 | 8 | 1/8 |
| D2-R2 | 5 | 1/5 |
| R2 | N/A | 0 |
| F1-D1 | 4 | 1/4 |
| F1-D2 | 10 | 1/10 |
| F1 | N/A | 0 |
| D1 | N/A | 0 |
| D2 | N/A | 0 |

As shown in Table 1, the priority management system 105 generates higher preliminary matching scores for transportation plans with lower ETAs. Accordingly, the highest (e.g., best) preliminary matching score involving the transportation vehicle D1 is the transportation plan that pairs the transportation vehicle D1 with the requestor R1 (for a preliminary matching score of 0.33). In addition, the highest preliminary matching score involving the transportation vehicle D2 is the transportation plan that pairs the transportation vehicle D2 with the requestor R2 (for a score of 0.2). Were the priority management system 105 to rely on the preliminary matching scores shown in Table 1 for generating and assigning transportation assignments, the prioritized requestor F1 for prioritized transport would be left unassigned to a transportation vehicle.

To ensure the priority management system 105 assigns a transportation vehicle to the prioritized requestor F1 for prioritized transport, in some embodiments, the priority management system 105 utilizes a prioritization factor that boosts or increases a preliminary matching score for a transportation plan that includes a prioritized requestor. Similarly, to mitigate or reduce system inefficiencies and unpleasant swaps for requestors and providers, in certain implementations, the priority management system 105 utilizes a prioritization factor that penalizes or decreases preliminary matching scores for certain transportation plans. For instance, in some embodiments, the priority management system 105 utilizes a prioritization factor as a guardrail to avoid providers and requestors experiencing multiple swaps or from ETAs increasing too much. In additional or alternative embodiments, the priority management system 105 utilizes a prioritization factor in generating updated transportation plans (e.g., to prioritize bumped/swapped providers and requestors as explained below).

As shown in FIG. 5B, the priority management system 105 can utilize a process 502 implementing acts and algorithms to modify preliminary matching scores with prioritization factors. In particular, and as described below, the priority management system 105 generates penalization factors (or “penalties”) based on determining certain metrics for transportation plans that indicate “unpleasant swaps” for requestors and/or providers. In these or other embodiments, an unpleasant swap refers to a negative requestor experience and/or provider experience caused by the priority management system 105 prioritizing pickup for one requestor over another requestor. Based on the type of unpleasant swap, the priority management system 105 can assess a different penalty for the corresponding transportation plan.

At act 504, the priority management system 105 can determine if there is prioritized transport in a given transportation plan. If yes, the priority management system 105 assesses a penalty 510 of zero (i.e., no penalty). If no, the priority management system 105 determines at act 506 if the requestor is unassigned after having been assigned previously.

Specifically, at act 506, the priority management system 105 identifies if a requestor is left without a transportation vehicle assigned for pickup when the requestor had one previously. The priority management system 105 considers this scenario as particularly negative for requestors and therefore assigns such transportation plans with requestors having assigned vehicles removed with a penalty 514 of 3M (i.e., 3*M), where M=UB−LB+1. The term UB represents a maximum score (e.g., a maximum preliminary matching score), and the term LB represents a minimum score (e.g., a minimum preliminary matching score).

If the requestor is not left without a transportation vehicle assigned for pickup as determined at act 506, the priority management system 105 proceeds to act 508 for making a series of assessments regarding an unpleasant swap. As example assessments that test for certain unpleasant swaps, the priority management system 105 determines (i) if the requestor's ETA increases in the transportation plan, (ii) if the requestor's ETA is more than a predetermined threshold (e.g., ten minutes, twenty minutes), (iii) if the provider's travel time to requestor(s) increases (e.g., time in in-transit-to-pickup status), (iv) if a transportation plan meets the maximum number of transportation reassignments for the provider device, or (v) if a transportation plan meets the maximum number of transportation reassignments for the requestor device.

If the priority management system 105 determines a “no” or a negative to all of these or other assessments at act 508, the priority management system 105 assesses the transportation plan with the penalty 510 of zero. Otherwise, if the priority management system 105 determines any one of the assessments at act 508 results in “yes” or an affirmative, the priority management system 105 assesses the transportation plan with a penalty 512 of 2M (i.e., 2*M). While not depicted in FIG. 5B, in some cases, the priority management system 105 can determine different penalties according to different scales for the penalty 512 or the penalty 514 (e.g., 3*M for the penalty 512 and 5*M for the penalty 514).

Under the approach for assessing penalties for some transportation plans in FIG. 5B, the penalty for any unpleasant swap is at least 2M. Additionally, as evident in Table 2 below, the difference between the preliminary matching score of any two transportation plans for non-prioritized transport is at most M−1. Accordingly, the priority management system 105 does not select any transportation plan with an unpleasant swap except in the presence of a boosting prioritization factor described below. For example, the priority management system 105 may select a transportation plan with an unpleasant swap as a result of the priority management system 105 selecting another transportation associated with a boosting prioritization factor.

Further, in one or more implementations, the priority management system 105 selects a transportation plan based on the size of the penalty. For instance, when a requestor loses an assigned provider under a potential transportation plan, the priority management system 105 assigns this transportation plan a large penalty of 3M. In this regard, the priority management system 105 may prefer to select a transportation plan with a penalty of 2M to avoid the more negative user experience.

In addition to the penalties assessed according to the process 502, the priority management system 105 can generate a prioritization factor that boosts a preliminary matching score for transportation plans involving prioritized transport. For example, in one or more embodiments, the priority management system 105 generates a boosting prioritization factor based on a value k representing a maximum number of candidate provider devices under consideration for prioritized transport of a requestor. To illustrate, the priority management system 105 can assign a transportation plan a prioritization factor of k*4*M, where the transportation plan pairs a prioritized requestor with a first provider device associated with a transportation vehicle closest to the prioritized requestor. Similarly, the priority management system 105 can assign a transportation plan a prioritization factor of (k−1)*4*M, where the transportation plan pairs the prioritized requestor with a second provider device associated with a transportation vehicle next (e.g., second) closest to the prioritized requestor. Thus, the priority management system 105 can assign a transportation plan a prioritization factor of (k−i+1)*4*M, where the transportation plan pairs the prioritized requestor with an i-th provider device associated with a transportation vehicle next (e.g., i-th) closest to the prioritized requestor.

Based on the foregoing approach for generating a boosting prioritization factor for a transportation plan, in some embodiments, the priority management system 105 generates a boosting prioritization factor that is greater than a largest penalizing prioritization factor, In some cases, the boosting prioritization factor is always greater than a largest penalizing prioritization factor—because the smallest boosting prioritization factor of (k−i+1)*4*M is greater than the largest penalizing prioritization factor of 3*M. Accordingly, after applying the penalizing and boosting prioritization factors just described to the preliminary matching scores, the priority management system 105 can select the transportation plans that prioritize transport of the prioritized requestor F1 and minimize unpleasant swaps for other requestors and providers.

Indeed, as shown in Table 2 below, the priority management system 105 can select the transportation plan associated with the highest matching score (e.g., 800.25 for the transportation plan of F1-D1) to prioritize the pickup for the prioritized requestor F1 according to a prioritized transportation option. In addition, the priority management system 105 can select a next highest scoring transportation plan from a remaining set of transportation plans (e.g., which do not include the prioritized requestor F1 or transportation vehicle D1). Specifically, the priority management system 105 can select the transportation plan of D2-R1 with a final matching score of −19.857. Of course, this selection of transportation plans leaves only a transportation plan of R2 being unassigned with a final matching score of zero. Though the ETA at a pickup location for the requestor R1 will increase by matching the transportation vehicle D2 with the requestor R1, the priority management system 105 can select this transportation plan in favor of prioritizing pickup for the requestor F1 by the transportation vehicle D1. To achieve the specific values shown in Table 2, let k=20 and M=10.

TABLE 2

| | | Preliminary | Penalizing | | Boosting | Final |
|---|---|---|---|---|---|---|
| Transportation | ETA | Matching | Prioritization | Reason for | Prioritization | Matching |
| Plan | (min) | Score | Factor | Penalty | Factor | Score |
| D1-R1 | 3 | 1/3 | 0 | | 0 | 0.333 |
| D2-R1 | 7 | 1/7 | 2M | ETA | 0 | −19.857 |
| | | | | increases | | |
| R1 | N/A | 0 | 3M | Unassigned | 0 | −30 |
| D1-R2 | 8 | 1/8 | 2M | Provider | 0 | 19.875 |
| | | | | Travel | | |
| | | | | Time | | |
| | | | | Increase | | |
| D2-R2 | 5 | 1/5 | 0 | | 0 | 0.2 |
| R2 | N/A | 0 | 0 | | 0 | 0 |
| F1-D1 | 4 | 1/4 | 0 | | k*4*M | 800.25 |
| F1-D2 | 10 | 1/10 | 0 | | (k-1)*4*M | 760.10 |
| F1 | N/A | 0 | 0 | | 0 | 0 |
| D1 | N/A | 0 | 0 | | 0 | 0 |
| D2 | N/A | 0 | 0 | | 0 | 0 |

In addition (or in the alternative to) penalizing or boosting factors, the priority management system 105 may utilize an optimization solver to determine a selection of transportation plans. For example, the priority management system 105 may combine the final matching scores of different combinations of transportation plans to identify combinations that result in a highest combination of matching scores. Based on a particular combination of final matching scores being greater than all other combinations, the priority management system 105 may select the transportation plans corresponding to the particular combination of final matching scores. For instance, the combination of final matching scores for the transportation plans of (i) F1-D1, (ii) D2-R1, and (iii) R2 sum to a combined final matching score of 780.393, which is greater than all other possible combinations for this example.

As shown in FIG. 5C, in some embodiments, the priority management system 105 can utilize a similar, but different approach to perform “chain bumping.” Under a chain-bumping approach, the priority management system 105 can spread out an ETA degradation among a set different requestors. For example, rather than one requestor experiencing a five-minute increase in ETA, five different requestors may experience a one-minute increase in ETA.

To implement this chain-bumping approach in generating matching scores for transportation plans, in some cases, the priority management system 105 utilizes a function C(x) for representing a penalizing prioritization factor based on ETA degradation for x seconds. In one or more implementations, the function C(x) has the following properties: (i) C(x)=M for x δ, (ii)

$${C}^{′ ( x )} = \frac{M}{δ} for x > δ ,$$

(iii) M≤C(x)≤Q, and (iv) Q>2M. In the immediately preceding expressions, the term M=C(δ)=UB−LB+1, and the term Q=C(Δ). In these or other embodiments, Δ is the largest possible ETA degradation. In addition, δ is the smallest ETA at which the priority management system 105 reduces via chain bumping (e.g., ETA degradation values less than δ are not chain-bumped or spread among multiple requestors).

As indicated by a process 520 shown in FIG. 5C, the priority management system 105 can determine at act 522 if there is prioritized transport in a given transportation plan. If yes, the priority management system 105 assesses a penalty 530 of zero (i.e., no penalty). If no, the priority management system 105 determines at act 524 if the requestor is unassigned after having been assigned previously. As mentioned above, the priority management system 105 penalizes transportation plans that indeed leave a requestor unassigned after having been assigned previously. However, in contrast to the process 502 in FIG. 5B, the priority management system 105 in the process 520 assesses a penalty 536 of Q for such transportation plans that leave a requestor unassigned after having been assigned previously.

Otherwise, if the priority management system 105 does not leave a request unassigned after having been assigned previously, the priority management system 105 determines at act 526 if a requestor's ETA increases according to a transportation plan. If yes, the priority management system 105 assesses a penalty 534 of C(x). If no, the priority management system 105 proceeds to act 528 for making a series of assessments regarding an “unpleasant swap” or negative user experience as described above in relation to FIG. 5B. As example assessments, the priority management system 105 determines (i), if the requestor's ETA is more than a predetermined threshold (e.g., ten minutes, twenty minutes), (ii) if the provider's travel time to requestor(s) increases (e.g., time in in-transit-to-pickup status), (iii) if a transportation plan meets the maximum number of transportation reassignments for the provider device, or (iv) if a transportation plan meets the maximum number of transportation reassignments for the requestor device.

If the priority management system 105 determines a “no” or a negative to all of these or other assessments at act 528, the priority management system 105 assesses the transportation plan with the penalty 530 of zero. Otherwise, if the priority management system 105 determines any one of the assessments at act 528 results in “yes” or an affirmative the priority management system 105 assesses the transportation plan with a penalty 532 of M. While not depicted in FIG. 5C, in some cases, the priority management system 105 can determine different penalties according to different scales for the penalty 532 or the penalty 534 (e.g., 2*M for the penalty 532, (2*M)+C(x) for the penalty 534, and (3*M)+Q for the penalty 536).

In addition to different penalizing prioritization factors, the priority management system 105 can also utilize different boosting prioritization factors than those described above. For example, in one or more embodiments, the priority management system 105 assigns a transportation plan a prioritization factor of k*(Q+M), where the transportation plan pairs a prioritized requestor with a first provider device associated with a transportation vehicle closest to the prioritized requestor. Similarly, the priority management system 105 can assign a transportation plan a prioritization factor of (k−1)*(Q+M), where the transportation plan pairs the prioritized requestor with a second provider device associated with a transportation vehicle next (e.g., second) closest to the prioritized requestor. Thus, the priority management system 105 can assign a transportation plan a prioritization factor of (k−i+1)*(Q+M), where the transportation plan pairs the prioritized requestor with an i-th provider device associated with a transportation vehicle next (e.g., i-th) closest to the prioritized requestor.

By applying the process 520 to generate corresponding penalizing prioritization factors and boosting prioritization factors as described, the priority management system 105 can generate a set of final matching scores as outlined below in Table 3 below. To achieve the specific values shown in Table 3, let k=20, C(4)=100, Q=1000, and M=10.

From the generated final matching scores in Table 3, the priority management system 105 can determine which transportation plans to select (e.g., as described above in relation to FIG. 5B). Although the final matching scores differ in Table 3 from Table 2, the priority management system 105 can select the same transportation plans in this particular example (e.g., transportation plans of (i) F1-D1, (ii) D2-R1, and (iii) R2). In other embodiments, however, the final matching scores according to the process 520 differ sufficiently enough such that the priority management system 105 selects different transportation plans than under the process 502 of FIG. 5B.

TABLE 3

| | | Preliminary | Penalizing | | Boosting | Final |
|---|---|---|---|---|---|---|
| Transportation | ETA | Matching | Prioritization | Reason for | Prioritization | Matching |
| Plan | (min) | Score | Factor | Penalty | Factor | Score |
| D1-R1 | 3 | 1/3 | 0 | | 0 | 0.333 |
| D2-R1 | 7 | 1/7 | C(4) | ETA | 0 | −99.857 |
| | | | | increases | | |
| R1 | N/A | 0 | Q | Unassigned | 0 | −1000 |
| D1-R2 | 8 | 1/8 | M | Provider | 0 | 9.875 |
| | | | | Travel | | |
| | | | | Time | | |
| | | | | Increase | | |
| D2-R2 | 5 | 1/5 | 0 | | 0 | 0.2 |
| R2 | N/A | 0 | 0 | | 0 | 0 |
| F1-D1 | 4 | 1/4 | 0 | | k*(Q + M) | 20200.25 |
| F1-D2 | 10 | 1/10 | 0 | | (k-1)*(Q + M) | 19190.10 |
| F1 | N/A | 0 | 0 | | 0 | 0 |
| D1 | N/A | 0 | 0 | | 0 | 0 |
| D2 | N/A | 0 | 0 | | 0 | 0 |

In one or more implementations, the priority management system 105 detects multiple prioritized requestors contending for the same set of transportation vehicles. Although the priority management system 105 can generate the same boosting prioritization factors for the contending prioritized requestors, the priority management system 105 can rely on other distinguishing factors for the respective potential transportation plans for each prioritized requestor (e.g., the preliminary matching scores, the penalizing prioritization factors). For instance, an ETA of 3 minutes for the transportation vehicle D1 to a pickup location of another prioritized requestor F2 (not shown) would likely result in the priority management system 105 selecting a transportation plan of D1-F2 (instead of D1-F1) given a slight edge in a corresponding preliminary matching score.

In these or other embodiments, the priority management system 105 can iteratively generate matching scores for additional or alternative transportation plans after executing a set of selected transportation plans (e.g., until an assigned provider device is within three minutes or 600 meters haversine to the pickup location). For example, in the event a provider or requestor is not matched or is left unassigned (e.g., as a result of bumping, swapping) in executing a set of transportation plans, the priority management system 105 can subsequently generate boosting prioritization factors to apply in a next set of transportation plans. For instance, where the requestor R2 remains unassigned in the example configuration of FIG. 5A, the priority management system 105 can generate a same or similar boosting prioritization factor (as discussed above) for a new set of transportation plans involving the requestor R2. In so doing, the priority management system 105 can (i) shorten the matching process time for the requestor R2 and (ii) prioritize the requestor R2 over other requestors contending for a same transportation vehicle.

In additional or alternative embodiments, the priority management system 105 may assign weighted values to transportation plans associated with a specific type of service category. For example, in one or more implementations, the priority management system 105 may prioritize a requestor for prioritized transport by taking a provider en route to a first requestor along a shared transportation route. Because requestors for shared transportation plans have self-identified as less time-sensitive requestors, the priority management system 105 can assign weighted values to providers for such shared transportation plans. Additionally or alternatively, the priority management system 105 may generate a lesser penalizing prioritization factor for increased ETAs of requestors in a shared transportation plan.

To illustrate, the priority management system 105 may prioritize a requestor for prioritized transport in a variety of shared transportation scenarios. In one example, the priority management system 105 prioritizes a requestor for prioritized transport by selecting a transportation plan that includes a provider device en route to a pickup location of another assigned requestor associated with a shared transportation option. In this example, the priority management system 105 may bump the other assigned requestor and assign a new provider device to the bumped requestor.

In another example, the priority management system 105 can prioritize a requestor for prioritized transport by selecting a transportation plan that changes an assignment of a provider device from a solo transport of a previously assigned requestor to a shared transport with a prioritized requestor. In this example, the priority management system 105 either (i) delays pickup of the previously assigned requestor for picking up the prioritized requestor or (ii) instructs the provider device to pick up the prioritized requestor after picking up the previously assigned requestor. In some cases, this transportation plan may score lower than other transportation plans because the previously assigned requestor originally requested solo transport.

In yet another example, the priority management system 105 can prioritize a requestor for prioritized transport by selecting a transportation plan that reroutes a provider device assigned to a shared transport to also pick up a prioritized requestor. According to such a transportation plan, the priority management system may instruct the provider device to pick up the requestor for prioritized requestor before and/or after other requestor(s) for shared transport. In some cases, the pickup order for shared transport depends on various factors described above. Additionally or alternatively, the priority management system 105 may prioritize or weight transportation plans based one or more of a fastest ETA to a pickup location for the prioritized requestor, a shortest trip duration for the prioritized requestor, or a fewest number of stops for the prioritized requestor prior to drop-off.

As mentioned above, the priority management system 105 can provide a prioritized transportation option to a requestor device based on a ghost-matching process. Upon execution of a prioritized transportation option, the priority management system 105 can, in certain implementations, update the requestor device to indicate that a faster (e.g., a closer provider) can provide the prioritized transport. FIGS. 6A-6D illustrate a computing device 600 presenting graphical user interfaces 602a-602d relating to a prioritized transportation option 604 in accordance with one or more embodiments.

In these or other embodiments, the computing device 600 comprises a requestor application for the dynamic transportation matching system 104. In some embodiments, the requestor application comprises computer-executable instructions that (upon execution) cause the computing device 600 to perform certain actions depicted in FIGS. 6A-6D, such as presenting a graphical user interface of the requestor application. Rather than refer to the dynamic transportation matching system 104 or the priority management system 105 as performing the actions depicted in FIGS. 6A-6D below, this disclosure will generally refer to the computing device 600 performing such actions for simplicity.

As shown in FIG. 6A, the priority management system 105 can ghost-match a specific provider for providing prioritized transport of a requestor associated with the computing device 600. As a result, the computing device 600 shown in FIG. 6A can display the graphical user interface 602a with the prioritized transportation option 604 comprising an ETA differential 608 that indicates a specific ETA improvement of “5 min” relative to an ETA 618a for a standard transportation option 612. For instance, in response to the computing device 600 receiving user input for (or otherwise populating) a current location or pickup location and/or a destination location for transportation route information 616, the computing device 600 can display the prioritized transportation option 604 among other transportation options (e.g., the standard transportation option 612, a shared transportation option 614).

As further shown in FIG. 6A, the prioritized transportation option 604 comprises a price differential 610 of $12.20 indicating the cost premium relative to the standard transportation option 612. Additionally, the prioritized transportation option 604 comprises a selectable toggle 606. Via the selectable toggle 606, the computing device 600 can visually indicate (e.g., by highlight or color) a selection of the prioritized transportation option 604. Otherwise, the computing device 600 can visually indicate a selection of one of the standard transportation option 612, the shared transportation options 614, or other options (viewable by scrolling or swiping down) in response to a user selection of the desired transportation option and a selection element 620.

As shown by the transition from FIG. 6A to FIG. 6B, in response to a user interaction with the selectable toggle 606 to select the prioritized transportation option 604, the computing device 600 dynamically updates the graphical user interface 602a to show the graphical user interface 602b. In particular, the computing device 600 moves the selectable toggle 606 in the graphical user interface 602b for display in the “on” or “selected” position. Moreover, the graphical user interface 602b includes a provider indicator 628 for a transportation vehicle 626 associated with a selected provider device for prioritized pickup of the requestor in “3 min” with an ETA 618b. Indeed, prior to submitting a prioritized transportation request via selection of a confirmation element 632, the computing device 600 can show a graphical representation of a mapped route 630 that indicates a path of travel for the transportation vehicle 626 to an identified pickup location 622 for prioritized pickup of the requestor (currently positioned at location 624).

As shown by the transition from FIG. 6B to FIG. 6C, in response to a user selection of the confirmation element 632, the computing device 600 can update the graphical user interface 602b to show the graphical user interface 602c. As shown in FIG. 6C, the graphical user interface 602c comprises a notification 633 indicating the selected provider (previously ghost-matched for this prioritized transport) is en route to the identified pickup location 622 for prioritized pickup. In these or other embodiments, as the transportation vehicle 626 proceeds towards the identified pickup location 622 along the graphical representation of the mapped route 630, the computing device 600 can dynamically update the positioning of the transportation vehicle 626 within the graphical user interface 602c. In addition, the computing device 600 can dynamically update an ETA 618c and/or an ETA 634a indicating an estimated time of arrival of the transportation vehicle 626 at the identified pickup location 622.

As further shown in FIG. 6C, the graphical user interface 602c comprises provider information 636a (e.g., name and picture of the provider; make, model, or license plate of the transportation vehicle 626). In addition, the graphical user interface 602c comprises selectable options 638 for editing the prioritized transportation request, sharing an ETA (e.g., ETA to destination or drop-off location via social media or text message or ETA of requestor to a pickup location via message to the provider), or contacting the provider en route to pick up.

As shown in FIG. 6D, based on the priority management system 105 iteratively searching for closer providers as described above, the computing device 600 shows that the priority management system 105 indeed found a provider with an earlier ETA. Specifically, in the graphical user interface 602d, the computing device 600 can display a notification 644 indicating that the priority management system 105 found a closer provider for prioritized pickup of the requestor at the identified pickup location 622.

As similarly described above, the computing device 600 can present the graphical user interface 602d comprising a transportation vehicle 640 associated with a selected provider device. In particular, the graphical user interface 602d indicates the transportation vehicle 640 traveling towards the identified pickup location 622 along a graphical representation of a mapped route 642 for an ETA 618d of “1 min.” As the transportation vehicle 640 makes progress along the mapped route 642, the computing device 600 can update the ETA 618d and/or an ETA 634b indicating an estimated time of arrival of the transportation vehicle 640 at the identified pickup location 622. As further shown in FIG. 6D, the graphical user interface 602d comprises provider information 636b that the computing device 600 dynamically updates to match the updated provider device selection of the priority management system 105.

As mentioned above, the priority management system 105 can improve ETAs for prioritized transportation options by flexibly including provider devices in in-transit-to-pickup status as candidate provider devices for prioritized transport. FIG. 7 illustrates a graph 700 indicating testing results of the priority management system 105 improving an estimated time of arrival metric in accordance with one or more embodiments. As shown in the graph 700, about ninety percent of transportations (or “rides”) from an example venue used in the test did not qualify for prioritized transport (albeit in other cases, this percentage can be higher or lower). However, by including provider devices in in-transit-to-pickup status as candidate provider devices for prioritized transport, the priority management system 105 provides an approximate 150-second ETA improvement to a pickup location for five percent of rides and a 250-second ETA improvement to a pickup location for about three percent of rides. In addition, the priority management system 105 provides more than seven minutes of ETA improvement for one percent of rides.

In further support of the graph 700, additional tests were conducted at discrete segments of a day/week at an example venue. The following Table 4 reflects these testing results and shows that the priority management system 105 is most effective during busy times (e.g., commuting times, party hours) when demand for shorter ETAs is highest. Table 4 further shows that the priority management system 105 can provide an average ETA improvement of 15.7 seconds using only provider devices in idle status. In contrast, the priority management system 105 can provide an average ETA improvement of 125.7 seconds with the flexible addition of in-transit-to-pickup supply as described within the present disclosure. By utilizing the dynamic approach of the present disclosure, in some embodiments, the priority management system 105 can improve ETAs even further by about 87.5 percent on average.

TABLE 4

| | | ETA |
|---|---|---|
| | | Improvement |
| | | (sec) with |
| | ETA | Idle and |
| | Improvement | In-Transit- |
| | (sec) with | To-Pickup |
| Time Category | Idle Supply | Supply |
| Weekend Evening | 15.3 | 126.1 |
| Evening Commute | 10.5 | 99.8 |
| Morning Commute | 20.9 | 145.7 |
| Weekday Daytime | 9.8 | 126.1 |
| Weekend Daytime | 10.7 | 105.6 |
| Weekend Late Evening | 11.6 | 106.1 |
| Weekday Evening | 7.9 | 87.3 |
| Weekend Early Morning | 20.6 | 147.8 |
| Weekday Early Morning | 31.1 | 187.1 |

As mentioned above, the priority management system 105 can utilize a combination of adaptive pricing mechanisms when implementing prioritized transport for requestors. FIG. 8 shows a graph 800 indicating testing results of the priority management system 105 implementing a combination of adaptive pricing mechanisms in accordance with one or more embodiments. As shown in FIG. 8, graph 800 comprises bars 802-814 corresponding to specific percentages of a transportation fare comprised of a Prime Time premium (e.g., a base premium for a transportation request during a busy or higher demand time frame) relative to a percentage of rides impacted by prioritized transportation. In particular, the bars 802-814 indicate respective Prime Time percentage values of 0, 25, 50, 75, 100, 125, and 150. For these discrete percentages, the priority management system 105 affects approximately 42%, 39%, 36%, 38%, 42%, 10%, and 49% of the respective rides as a result of prioritizing some requestors over others using prioritized transportation options. Thus, the graph 800 indicates that the priority management system 105 can execute (in a roughly consistent manner) prioritized transportation options on top of different levels of Prime Time percentages (including higher Prime Time percentages).

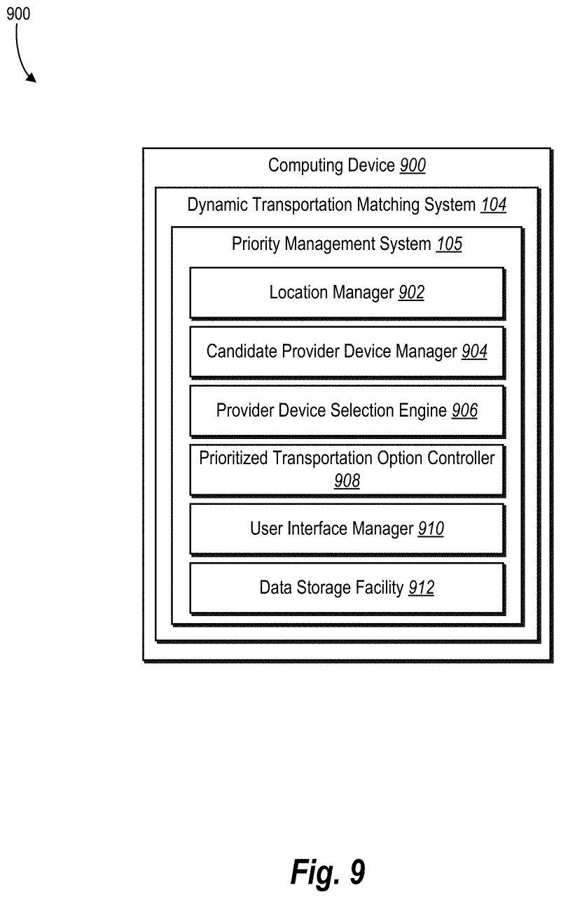

Turning to FIG. 9 additional detail will now be provided regarding various components and capabilities of the priority management system 105. In particular, FIG. 9 illustrates an example schematic diagram of a computing device 900 (e.g., the server(s) 102, the provider devices 110a-110n, the requestor devices 116a-116n, and/or the computing device 600) implementing the priority management system 105 in accordance with one or more embodiments of the present disclosure. As shown, the priority management system 105 is further implemented by the server(s) 102 and the dynamic transportation matching system 104. Also illustrated, the priority management system 105 can include a location manager 902, a candidate provider device manager 904, a provider device selection engine 906, a prioritized transportation option controller 908, a user interface manager 910, and a data storage facility 912.

The location manager 902 can provide, request, track, store, analyze, or identify locations of requestor devices and provider devices (as described in relation to the foregoing figures). In particular, the location manager 902 can obtain real-time GPS data of requestor devices and provider devices. For example, the location manager 902 can, in response to a requestor device accessing a requestor application and/or providing a destination location, determine a pickup location for prioritized transport of a requestor.

The candidate provider device manager 904 can analyze location data from the location manager 902 in connection with a transportation-assignment status of provider devices to determine candidate provider devices for prioritized transport of a requestor (as described in relation to the foregoing figures). In particular, the candidate provider device manager 904 can identify provider devices that are positioned (i) within a threshold distance to the pickup location for the requestor or (ii) within a same geocoded region or geocoded area as the pickup location for the requestor. In addition, the candidate provider device manager 904 can exclude certain provider devices from candidate provider devices for prioritized transport of the requestor (e.g., the provider devices having an active-transport status).

The provider device selection engine 906 can select a provider device from the candidate provider devices identified by the candidate provider device manager 904 (as described in relation to the foregoing figures). In particular, the provider device selection engine 906 can compare ETAs associated with the candidate provider devices and select the provider device associated with an earliest ETA at the pickup location of the requestor device. Additionally, in some embodiments, the provider device selection engine 906 can coordinate with the candidate provider device manager 904 to iteratively search for and select a candidate provider device with an earlier ETA at the identified pickup location for the requestor.

The prioritized transportation option controller 908 can dynamically assess whether to provide a prioritized transportation option (as described in relation to the foregoing figures). In particular, the prioritized transportation option controller 908 can analyze requestor profile data, such as a travel history or previously requested upgrades to determine a probability that the requestor would select a prioritized transportation option. In addition, the prioritized transportation option controller 908 can determine a current offer metric for prioritized transport in relation to a prioritized-transportation limit for prioritized transportation options. Accordingly, in some embodiments, the prioritized transportation option controller 908 can, prior to a requestor device selecting and/or confirming a prioritized transportation option presented to the requestor device, remove the prioritized transportation option for display at the requestor device.

The user interface manager 910 can provide, manage, and/or control a graphical user interface (or simply “user interface”). In particular, the user interface manager 910 may generate and display a user interface by way of a display screen composed of a plurality of graphical components, objects, and/or elements that allow a user to perform a function. For example, the user interface manager 910 can receive user inputs from a user, such as a click/tap to select a prioritized transportation option. Additionally, the user interface manager 910 can present a variety of types of information, including text, provider indicators, depictions of transportation routes

The data storage facility 912 maintains data for the priority management system 105. The data storage facility 912 (e.g., via one or more memory devices) can maintain data of any type, size, or kind, as necessary to perform the functions of the priority management system 105. In one or more embodiments, the data storage facility 912 stores requestor profile data and the like.

Each of the components of the computing device 900 can include software, hardware, or both. For example, the components of the computing device 900 can include one or more instructions stored on a computer-readable storage medium and executable by processors of one or more computing devices, such as a client device or server device. When executed by the one or more processors, the computer-executable instructions of the priority management system 105 can cause the computing device(s) (e.g., the computing device 900) to perform the methods described herein. Alternatively, the components of the computing device 900 can include hardware, such as a special-purpose processing device to perform a certain function or group of functions. Alternatively, the components of the computing device 900 can include a combination of computer-executable instructions and hardware.

Furthermore, the components of the computing device 900 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the computing device 900 may be implemented as a stand-alone application, such as a desktop or mobile application. Furthermore, the components of the computing device 900 may be implemented as one or more web-based applications hosted on a remote server. Additionally or alternatively, the components of the computing device 900 may also be implemented in a suite of mobile device applications or “apps.”

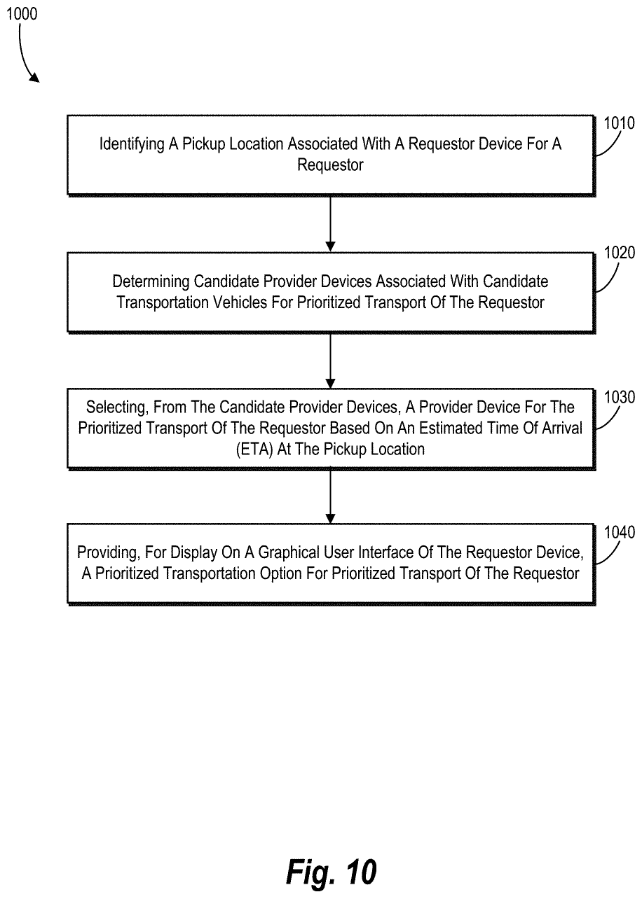

FIGS. 1-9, the corresponding text, and the examples provide several different systems, methods, techniques, components, and/or devices of the priority management system 105 in accordance with one or more embodiments. In addition to the above description, one or more embodiments can also be described in terms of flowcharts including acts for accomplishing a particular result. For example, FIG. 10 illustrates a flowchart of a series of acts 1000 for providing a prioritized transportation option in accordance with one or more embodiments. The priority management system 105 may perform one or more acts of the series of acts 1000 in addition to or alternatively to one or more acts described in conjunction with other figures. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown, the series of acts 1000 includes an act 1010 of identifying a pickup location associated with a requestor device for a requestor. The series of acts 1000 further includes an act 1020 of determining candidate provider devices associated with candidate transportation vehicles for prioritized transport of the requestor. In these or other embodiments, the candidate provider devices comprise assigned provider devices associated with requestors and unassigned provider devices not associated with requestors.

In addition, the series of acts 1000 further includes an act 1030 of selecting, from the candidate provider devices, a provider device for the prioritized transport of the requestor based on an estimated time of arrival (ETA) at the pickup location (e.g., of a transportation vehicle associated with the provider device). In some embodiments, selecting the provider device for the prioritized transport of the requestor comprises: comparing ETAs at the pickup location of the candidate transportation vehicles associated with the candidate provider devices; and selecting the provider device based on the ETA at the pickup location of the transportation vehicle being less than other ETAs at the pickup location of other candidate transportation vehicles from the candidate transportation vehicles.

The series of acts 1000 further includes an act 1040 of providing, for display on a graphical user interface of the requestor device, a prioritized transportation option for prioritized transport of the requestor (e.g., by the transportation vehicle associated with the provider device). In some embodiments, providing the prioritized transportation option within the graphical user interface comprises at least one of: a provider indicator for a provider associated with the provider device; or a graphical representation of a mapped route for the transportation vehicle to travel to the pickup location.

Additionally or alternatively, providing the prioritized transportation option at act 1040 within the graphical user interface comprises at least one of: an ETA differential that indicates a difference between an initial ETA at the pickup location of an initial transportation vehicle according to a standard transportation option and the ETA at the pickup location of the transportation vehicle according to the prioritized transportation option; or a price differential that indicates a difference between a standard cost for the standard transportation option and a premium cost for the prioritized transportation option.

It is understood that the outlined acts in the series of acts 1000 are only provided as examples, and some of the acts may be optional, combined into fewer acts, or expanded into additional acts without detracting from the essence of the disclosed embodiments. Additionally, the acts described herein may be repeated or performed in parallel with one another or in parallel with different instances of the same or similar acts. As an example of an additional act not shown in FIG. 10, act(s) in the series of acts 1000 may include: determining the provider device is assigned to pick up an initial requestor at an initial pickup location; receiving an indication of a selection of the prioritized transportation option from the requestor device; and modifying a transportation assignment for the provider device to pick up the requestor at the pickup location instead of the initial requestor at the initial pickup location.

As another example of an additional act not shown in FIG. 10, act(s) in the series of acts 1000 may include: determining the provider device for the prioritized transport of the requestor is not assigned to a particular requestor; determining that the ETA at the pickup location of the transportation vehicle associated with the provider device is both: (i) later than an alternative ETA at an alternative pickup location of the transportation vehicle for an alternative requestor corresponding to a standard transportation option; and (ii) earlier than other ETAs at the pickup location of other candidate transportation vehicles associated with other candidate provider devices; and based on determining that the ETA at the pickup location of the transportation vehicle is earlier than the other ETAs at the pickup location of the other candidate transportation vehicles, selecting the provider device for the prioritized transport of the requestor corresponding to the prioritized transportation option rather than for a standard transport of the alternative requestor corresponding to the standard transportation option.

In yet another example of an additional act not shown in FIG. 10, act(s) in the series of acts 1000 may include: receiving an indication of a selection of the prioritized transportation option from the requestor device; identifying an unassigned provider device corresponding to an unassigned transportation vehicle having an earlier (e.g., a lesser) ETA at the pickup location than the ETA at the pickup location of the transportation vehicle associated with the provider device initially selected for the prioritized transport of the requestor; and based on identifying the unassigned provider device corresponding to the unassigned transportation vehicle having the earlier ETA: (i) sending a matched transportation assignment to the unassigned provider device for the unassigned transportation vehicle to pick up the requestor at the pickup location; and (ii) sending a notification to the provider device initially selected for the prioritized transport of the requestor to not pick up the requestor.

As still another example of an additional act not shown in FIG. 10, act(s) in the series of acts 1000 may include: determining the provider device is assigned to pick up an initial requestor at an initial pickup location; after selecting the provider device for the prioritized transport of the requestor, generating one or more matching scores for the initial requestor based on a prioritization factor that increases a priority of matching the initial requestor relative to other requestors; and selecting an alternative provider device for transport of the initial requestor at the initial pickup location based on the one or more matching scores.

As a further example of an additional act not shown in FIG. 10, act(s) in the series of acts 1000 may include: selecting an alternative provider device associated with an alternative transportation vehicle for the prioritized transport of the requestor, rather than the provider device initially selected for the prioritized transport of the requestor, based on the alternative transportation vehicle having an earlier ETA at the pickup location; generating one or more matching scores for the provider device initially selected for the prioritized transport of the requestor based on a prioritization factor that increases a priority of matching the provider device relative to other provider devices; and selecting the provider device for transport of another requestor based on the one or more matching scores.

As an additional example of an additional act not shown in FIG. 10, act(s) in the series of acts 1000 may include: selecting an alternative provider device associated with an alternative transportation vehicle for the prioritized transport of the requestor, rather than the provider device initially selected for the prioritized transport of the requestor, based on the alternative transportation vehicle having an earlier ETA at the pickup location; determining a time or distance traveled toward the pickup location by the transportation vehicle associated with the provider device initially selected for the prioritized transport of the requestor; and providing, to the provider device initially selected for the prioritized transport of the requestor, a compensation value based on the determined time or the determined distance.

As another example of an additional act not shown in FIG. 10, act(s) in the series of acts 1000 may include: determining the candidate provider devices associated with the candidate transportation vehicles are unavailable for the prioritized transport of the requestor; and remove, for display on the graphical user interface of the requestor device, the prioritized transportation option based on determining the candidate provider devices are unavailable for the prioritized transport of the requestor.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

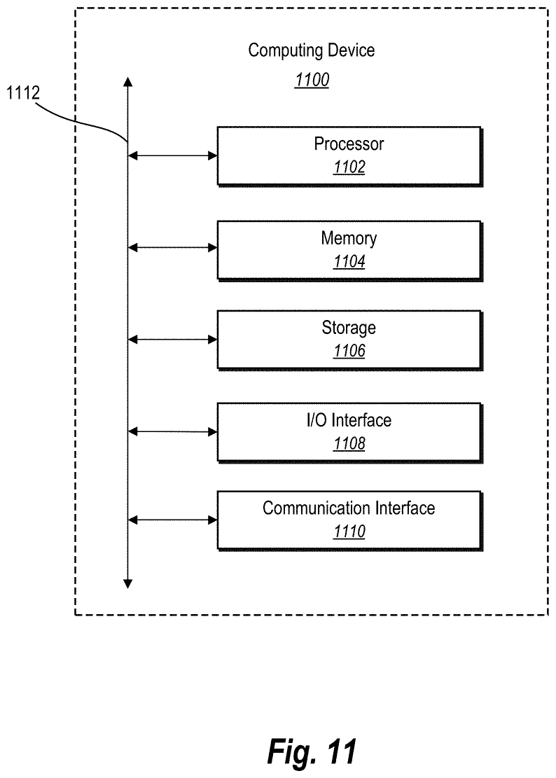

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 102, the provider devices 110a-110n, the requestor devices 116a-116n, the computing device 600, and/or the computing device 900). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of the computing device 1100 to each other.

FIG. 12 illustrates an example network environment 1200 of a transportation matching system (e.g., the dynamic transportation matching system 104). The network environment 1200 includes a client device 1206, a transportation matching system 1202, and a vehicle subsystem 1208 connected to each other by a network 1204. Although FIG. 12 illustrates a particular arrangement of the client device 1206, the transportation matching system 1202, the vehicle subsystem 1208, and the network 1204, this disclosure contemplates any suitable arrangement of the client device 1206, the transportation matching system 1202, the vehicle subsystem 1208, and the network 1204. As an example, and not by way of limitation, two or more of the client devices 1206, the transportation matching system 1202, and the vehicle subsystem 1208 communicate directly, bypassing the network 1204. As another example, two or more of the client devices 1206, the transportation matching system 1202, and the vehicle subsystem 1208 may be physically or logically co-located with each other in whole or in part. Moreover, although FIG. 12 illustrates a particular number of the client devices 1206, the transportation matching systems 1202, the vehicle subsystems 1208, and the networks 1204, this disclosure contemplates any suitable number of the client devices 1206, the transportation matching systems 1202, the vehicle subsystems 1208, and the networks 1204. As an example, and not by way of limitation, the network environment 1200 may include multiple client devices 1206, the transportation matching systems 1202, the vehicle subsystems 1208, and the networks 1204.

This disclosure contemplates any suitable network 1204. As an example, and not by way of limitation, one or more portions of the network 1204 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 1204 may include one or more networks 1204.

Links may connect the client device 1206, the transportation matching system 1202, and the vehicle subsystem 1208 to the network 1204 or to each other. This disclosure contemplates any suitable links. In particular embodiments, one or more links include one or more wireline (such as for example Digital Subscriber Line (DSL) or Data Over Cable Service Interface Specification (DOCSIS), wireless (such as for example Wi-Fi or Worldwide Interoperability for Microwave Access (WiMAX), or optical (such as for example Synchronous Optical Network (SONET) or Synchronous Digital Hierarchy (SDH) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by the client device 1206. As an example, and not by way of limitation, a client device 1206 may include any of the computing devices discussed above in relation to FIG. 12. A client device 1206 may enable a network user at the client device 1206 to access a network. A client device 1206 may enable its user to communicate with other users at other client devices 1206.

In particular embodiments, the client device 1206 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1206 may enter a Uniform Resource Locator (URL) or other address directing the web browser to a particular server (such as server), and the web browser may generate a Hyper Text Transfer Protocol (HTTP) request and communicate the HTTP request to server. The server may accept the HTTP request and communicate to client device 1206 one or more Hyper Text Markup Language (HTML) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 1202 may be a network-addressable computing system that can host a ride share transportation network. The transportation matching system 1202 may generate, store, receive, and send data, such as, for example, user-profile data, concept-profile data, text data, ride request data, GPS location data, provider data, requestor data, vehicle data, or other suitable data related to the ride share transportation network. This may include authenticating the identity of providers and/or vehicles who are authorized to provide ride services through the transportation matching system 1202. In addition, the transportation service system may manage identities of service requestors such as users/requestors. In particular, the transportation service system may maintain requestor data such as driving/riding histories, personal data, or other user data in addition to navigation and/or traffic management services or other location services (e.g., GPS services).

In particular embodiments, the transportation matching system 1202 may manage ride matching services to connect a user/requestor with a vehicle and/or provider. By managing the ride matching services, the transportation matching system 1202 can manage the distribution and allocation of vehicle subsystem resources and user resources such as GPS location and availability indicators, as described herein.

The transportation matching system 1202 may be accessed by the other components of the network environment 1200 either directly or via network 1204. In particular embodiments, the transportation matching system 1202 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 1202 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or a transportation matching system 1202 to manage, retrieve, modify, add, or delete, the information stored in data store.

In particular embodiments, the transportation matching system 1202 may provide users with the ability to take actions on various types of items or objects, supported by the transportation matching system 1202. As an example, and not by way of limitation, the items and objects may include ride share networks to which users of the transportation matching system 1202 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 1202 or by an external system of a third-party system, which is separate from the transportation matching system 1202 and coupled to the transportation matching system 1202 via a network 1204.

In particular embodiments, the transportation matching system 1202 may be capable of linking a variety of entities. As an example, and not by way of limitation, the transportation matching system 1202 may enable users to interact with each other or other entities, or to allow users to interact with these entities through an application programming interfaces (API) or other communication channels.

In particular embodiments, the transportation matching system 1202 may include a variety of servers, sub-systems, programs, modules, logs, and data stores. In particular embodiments, the transportation matching system 1202 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 1202 may also include suitable components such as network interfaces, security mechanisms, load balancers, failover servers, management-and-network-operations consoles, other suitable components, or any suitable combination thereof. In particular embodiments, the transportation matching system 1202 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 1202 and one or more client devices 1206. An action logger may be used to receive communications from a web server about a user's actions on or off the transportation matching system 1202. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from the client device 1206 responsive to a request received from the client device 1206. Authorization servers may be used to enforce one or more privacy settings of the users of the transportation matching system 1202. A privacy setting of a user determines how particular information associated with a user can be shared. The authorization server may allow users to opt in to or opt out of having their actions logged by the transportation matching system 1202 or shared with other systems, such as, for example, by setting appropriate privacy settings. Third-party-content-object stores may be used to store content objects received from third parties. Location stores may be used for storing location information received from the client devices 1206 associated with users.

In addition, the vehicle subsystem 1208 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 1208 can include an autonomous vehicle—i.e., a vehicle that does not require a human operator. In these embodiments, the vehicle subsystem 1208 can perform maneuvers, communicate, and otherwise function without the aid of a human provider, in accordance with available technology.

In particular embodiments, the vehicle subsystem 1208 may include one or more sensors incorporated therein or associated thereto. For example, sensor(s) can be mounted on the top of the vehicle subsystem 1208 or else can be located within the interior of the vehicle subsystem 1208. In certain embodiments, the sensor(s) can be located in multiple areas at once i.e., split up throughout the vehicle subsystem 1208 so that different components of the sensor(s) can be placed in different locations in accordance with optimal operation of the sensor(s). In these embodiments, the sensor(s) can include a LIDAR sensor and an inertial measurement unit (IMU) including one or more accelerometers, one or more gyroscopes, and one or more magnetometers. The sensor suite can additionally or alternatively include a wireless IMU (WIMU), one or more cameras, one or more microphones, or other sensors or data input devices capable of receiving and/or recording information relating to navigating a route to pick up, transport, and/or drop off a requestor.

In particular embodiments, the vehicle subsystem 1208 may include a communication device capable of communicating with the client device 1206 and/or the transportation matching system 1202. For example, the vehicle subsystem 1208 can include an on-board computing device communicatively linked to the network 1204 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
identifying a pickup location associated with a requestor device for a requestor;
determining candidate provider devices associated with candidate transportation vehicles for prioritized transport of the requestor, the candidate provider devices comprising assigned provider devices associated with requestors and unassigned provider devices not associated with requestors;
selecting, from the candidate provider devices, a provider device for the prioritized transport of the requestor based on an estimated time to arrival (ETA) at the pickup location of a transportation vehicle associated with the provider device; and
providing, for display on a graphical user interface of the requestor device, a prioritized transportation option for prioritized transport of the requestor by the transportation vehicle associated with the provider device.

2. The method of claim 1, further comprising providing the prioritized transportation option within the graphical user interface comprising at least one of:
a provider indicator for a provider associated with the provider device; or
a graphical representation of a mapped route for the transportation vehicle to travel to the pickup location.

3. The method of claim 1, further comprising providing the prioritized transportation option within the graphical user interface comprising at least one of:
an ETA differential that indicates a difference between an initial ETA at the pickup location of an initial transportation vehicle according to a standard transportation option and the ETA at the pickup location of the transportation vehicle according to the prioritized transportation option; or
a price differential that indicates a difference between a standard cost for the standard transportation option and a premium cost for the prioritized transportation option.

4. The method of claim 1, wherein selecting the provider device for the prioritized transport of the requestor comprises:
comparing ETAs at the pickup location of the candidate transportation vehicles associated with the candidate provider devices; and
selecting the provider device based on the ETA at the pickup location of the transportation vehicle being less than other ETAs at the pickup location of other candidate transportation vehicles from the candidate transportation vehicles.

5. The method of claim 1, further comprising:
determining the provider device is assigned to pick up an initial requestor at an initial pickup location;
receiving an indication of a selection of the prioritized transportation option from the requestor device; and
modifying a transportation assignment for the provider device to pick up the requestor at the pickup location instead of the initial requestor at the initial pickup location.

6. The method of claim 1, further comprising:
determining the provider device for the prioritized transport of the requestor is not assigned to a particular requestor;
determining that the ETA at the pickup location of the transportation vehicle associated with the provider device is both:
later than an alternative ETA at an alternative pickup location of the transportation vehicle for an alternative requestor corresponding to a standard transportation option; and
earlier than other ETAs at the pickup location of other candidate transportation vehicles associated with other candidate provider devices; and
based on determining that the ETA at the pickup location of the transportation vehicle is earlier than the other ETAs at the pickup location of the other candidate transportation vehicles, selecting the provider device for the prioritized transport of the requestor corresponding to the prioritized transportation option rather than for a standard transport of the alternative requestor corresponding to the standard transportation option.

7. The method of claim 1, further comprising:
receiving an indication of a selection of the prioritized transportation option from the requestor device;
identifying an unassigned provider device corresponding to an unassigned transportation vehicle having an earlier ETA at the pickup location than the ETA at the pickup location of the transportation vehicle associated with the provider device initially selected for the prioritized transport of the requestor; and
based on identifying the unassigned provider device corresponding to the unassigned transportation vehicle having the earlier ETA:
sending a matched transportation assignment to the unassigned provider device for the unassigned transportation vehicle to pick up the requestor at the pickup location; and
sending a notification to the provider device initially selected for the prioritized transport of the requestor to not pick up the requestor.

8. A system comprising:
at least one processor; and
at least one non-transitory computer-readable storage medium storing instructions that, when executed by the at least one processor, cause the system to:
identify a pickup location associated with a requestor device for a requestor;
determine candidate provider devices associated with candidate transportation vehicles for prioritized transport of the requestor, the candidate provider devices comprising assigned provider devices associated with requestors and unassigned provider devices not associated with requestors;
select, from the candidate provider devices, a provider device for the prioritized transport of the requestor based on an estimated time to arrival (ETA) at the pickup location of a transportation vehicle associated with the provider device; and
provide, for display on a graphical user interface of the requestor device, a prioritized transportation option for prioritized transport of the requestor by the transportation vehicle associated with the provider device.

9. The system of claim 8, further comprising instructions that, when executed by the at least one processor, cause the system to provide the prioritized transportation option within the graphical user interface comprising at least one of:
a provider indicator for a provider associated with the provider device;
a graphical representation of a mapped route for the transportation vehicle to travel to the pickup location;
an ETA differential that indicates a difference between an initial ETA at the pickup location of an initial transportation vehicle according to a standard transportation option and the ETA at the pickup location of the transportation vehicle according to the prioritized transportation option; or
a price differential that indicates a difference between a standard cost for the standard transportation option and a premium cost for the prioritized transportation option.

10. The system of claim 8, further comprising instructions that, when executed by the at least one processor, cause the system to:
determine the provider device is assigned to pick up an initial requestor at an initial pickup location;
after selecting the provider device for the prioritized transport of the requestor, generate one or more matching scores for the initial requestor based on a prioritization factor that increases a priority of matching the initial requestor relative to other requestors; and
select an alternative provider device for transport of the initial requestor at the initial pickup location based on the one or more matching scores.

11. The system of claim 8, further comprising instructions that, when executed by the at least one processor, cause the system to:
select an alternative provider device associated with an alternative transportation vehicle for the prioritized transport of the requestor, rather than the provider device initially selected for the prioritized transport of the requestor, based on the alternative transportation vehicle having an earlier ETA at the pickup location;
generate one or more matching scores for the provider device initially selected for the prioritized transport of the requestor based on a prioritization factor that increases a priority of matching the provider device relative to other provider devices; and
select the provider device for transport of another requestor based on the one or more matching scores.

12. The system of claim 8, further comprising instructions that, when executed by the at least one processor, cause the system to:
select an alternative provider device associated with an alternative transportation vehicle for the prioritized transport of the requestor, rather than the provider device initially selected for the prioritized transport of the requestor, based on the alternative transportation vehicle having an earlier ETA at the pickup location;
determine a time or distance traveled toward the pickup location by the transportation vehicle associated with the provider device initially selected for the prioritized transport of the requestor; and
providing, to the provider device initially selected for the prioritized transport of the requestor, a compensation value based on the determined time or the determined distance.

13. The system of claim 8, further comprising instructions that, when executed by the at least one processor, cause the system to select the provider device for the prioritized transport of the requestor by:
comparing ETAs at the pickup location of the candidate transportation vehicles associated with the candidate provider devices; and
selecting the provider device based on the ETA at the pickup location of the transportation vehicle being less than other ETAs at the pickup location of other candidate transportation vehicles from the candidate transportation vehicles.

14. The system of claim 8, further comprising instructions that, when executed by the at least one processor, cause the system to:
determine the provider device is assigned to pick up an initial requestor at an initial pickup location;
receive an indication of a selection of the prioritized transportation option from the requestor device; and
modify a transportation assignment for the provider device to pick up the requestor at the pickup location instead of the initial requestor at the initial pickup location.

15. A non-transitory computer-readable medium storing instructions that, when executed by at least one processor, cause a computing device to:
identify a pickup location associated with a requestor device for a requestor;
determine candidate provider devices associated with candidate transportation vehicles for prioritized transport of the requestor, the candidate provider devices comprising assigned provider devices associated with requestors and unassigned provider devices not associated with requestors;
select, from the candidate provider devices, a provider device for the prioritized transport of the requestor based on an estimated time to arrival (ETA) at the pickup location of a transportation vehicle associated with the provider device; and
provide, for display on a graphical user interface of the requestor device, a prioritized transportation option for prioritized transport of the requestor by the transportation vehicle associated with the provider device.

16. The non-transitory computer-readable medium of claim 15, further comprising instructions that, when executed by the at least one processor, cause the computing device to:
determine the provider device is assigned to pick up an initial requestor at an initial pickup location;
after selecting the provider device for the prioritized transport of the requestor, generate one or more matching scores for the initial requestor based on a prioritization factor that increases a priority of matching the initial requestor relative to other requestors; and
select an alternative provider device for transport of the initial requestor at the initial pickup location based on the one or more matching scores.

17. The non-transitory computer-readable medium of claim 15, further comprising instructions that, when executed by the at least one processor, cause the computing device to:
determine the candidate provider devices associated with the candidate transportation vehicles are unavailable for the prioritized transport of the requestor; and
remove, for display on the graphical user interface of the requestor device, the prioritized transportation option based on determining the candidate provider devices are unavailable for the prioritized transport of the requestor.

18. The non-transitory computer-readable medium of claim 15, further comprising instructions that, when executed by the at least one processor, cause the computing device to:
receive an indication of a selection of the prioritized transportation option from the requestor device;
identify an unassigned provider device corresponding to an unassigned transportation vehicle that has an additional ETA at the pickup location less than the ETA at the pickup location of the transportation vehicle associated with the provider device initially selected for the prioritized transport of the requestor; and
based on identifying the unassigned provider device corresponding to the unassigned transportation vehicle having the lesser ETA:
send a matched transportation assignment to the unassigned provider device for the unassigned transportation vehicle to pick up the requestor at the pickup location; and
send a notification to the provider device initially selected for the prioritized transport of the requestor to not pick up the requestor.

19. The non-transitory computer-readable medium of claim 15, further comprising instructions that, when executed by the at least one processor, cause the computing device to:
determine the provider device for the prioritized transport of the requestor is not assigned to a particular requestor;
determine that the ETA at the pickup location of the transportation vehicle associated with the provider device is both:
later than an alternative ETA at an alternative pickup location of the transportation vehicle for an alternative requestor corresponding to a standard transportation option; and
earlier than other ETAs at the pickup location of other candidate transportation vehicles associated with other candidate provider devices; and
based on determining that the ETA at the pickup location of the transportation vehicle is earlier than the other ETAs at the pickup location of the other candidate transportation vehicles, select the provider device for the prioritized transport of the requestor corresponding to the prioritized transportation option rather than for a standard transport of the alternative requestor corresponding to the standard transportation option.

20. The non-transitory computer-readable medium of claim 15, further comprising instructions that, when executed by the at least one processor, cause the computing device to:
determine the provider device is assigned to pick up an initial requestor at an initial pickup location;
receive an indication of a selection of the prioritized transportation option from the requestor device; and
modify a transportation assignment for the provider device to pick up the requestor at the pickup location instead of the initial requestor at the initial pickup location.
